(19) United States
(12) Patent Application Publication
(10) Pub. No.: US 2013/0226710 A1
(43) Pub. Date: Aug. 29, 2013

(54) AD CREATION INTERFACE FOR AN INTERPERSONAL ELECTRONIC ADVERTISING SYSTEM

(71) Applicant: William J. Plut, Los Altos, CA (US)

(72) Inventor: William J. Plut, Los Altos, CA (US)

(73) Assignee: TrustedAd, Inc., Menlo Park, CA (US)

(21) Appl. No.: 13/407,591

(22) Filed: Feb. 28, 2012

(51) Int. Cl. G06Q 30/02

(52) U.S. Cl. 705/14.67

(57) ABSTRACT

An ad creation interface for use in an interpersonal electronic advertising system is described. The ad creation interface is configured to enable an ad suggester to create interpersonal ads for a product or service for provision to an ad recipient. The suggested ad can lead to a purchase of the product or the service by the ad recipient and in response the system can compensate the ad suggester. The ad creation interface allows an individual to create a suggested ad. In particular, via the interface an individual can 1) specify an ad recipient that is to receive the ad, 2) search for and select a suggested ad to send to the recipient and 3) request the system to send the selected suggested ad including a personal message to the ad recipient.

### FIELD OF THE INVENTION

This invention generally relates to electronic advertising, and more particularly to systems and methods that allow a user to create custom ads within an interpersonal electronic advertising system.

### BACKGROUND

Advertising plays a central role in marketing and selling products and services. Current online advertisement providers send an advertisement to an advertisement recipient based on demographic characteristics and past contextual knowledge of the recipient, such as the online traffic content, or using information gathered from Internet searches, email content, or location detection technology.

For a number of reasons, these automated forms of advertisement based on prior online knowledge suffer from a relatively low ratio of conversion into actual purchases. First, advertisement recipients are inundated with irrelevant advertisements that collectively desensitize a viewer because the advertisements are not relevant to their current needs. Advertisements frequently show a product that has already been purchased. A person's needs change. For example, if an Internet user builds a car online at a car manufacturer's site, then the person will continue to receive ads for that car, irrespective if they actually liked the car, or whether they found a better car. More importantly, some advertisement providers selfishly display ads according to their highest paying advertiser. This is clearly not in the best interest of a particular ad recipient.

Based on the foregoing, there is a need for systems and methods for improved electronic advertising.

### BRIEF DESCRIPTION OF THE DRAWINGS

FIG. 1 illustrates a system for sending an interpersonal electronic advertisement in accordance with the described embodiments.

FIG. 2 illustrates a flow chart of a method for sending a suggested electronic advertisement and attributing compensation in accordance with the described embodiments.

FIG. 3 illustrates a graphical user interface for displaying a viewable page including one or more suggested ads in accordance with the described embodiments.

FIG. 4 illustrates a screen layout for a dashboard interface configured to allow a user to monitor their activities in an interpersonal electronic advertising system in accordance with the described embodiments.

FIG. 5 illustrate graphical depiction of suggested ads that can be displayed in a user interface associated with an interpersonal electronic advertising system in accordance with the described embodiments.

FIG. 6 illustrates a home state of an ad creation interface for an interpersonal electronic advertising system in accordance with the described embodiments.

FIG. 7 illustrates a state of an ad creation interface for specifying an ad recipient for a suggested ad in accordance with the described embodiments.

FIGS. 8A and 8B illustrate states of an ad creation interface for finding and selecting a product or service to use in a suggested ad in accordance with the described embodiments.

FIG. 9 illustrates a state of an ad creation interface for previewing and sending a suggested ad in accordance with the described embodiments.

FIG. 10 illustrates a state of an ad creation interface for directing a user to sign-in or register for an account in accordance with the describe embodiments.

FIG. 11 illustrates a state of ad creation interface for generating a new user account in accordance with the described embodiments.

FIG. 12 illustrates a state of an ad creation interface for logging in an existing user in accordance with the described embodiments.

FIG. 13 illustrates a home state of an ad creation interface for a logged in user in accordance with the described embodiments.

FIG. 14 illustrates a state of an ad creation interface for specifying an ad recipient for a user logged into an interpersonal electronic advertising system in accordance with the preferred embodiments.

FIG. 15 illustrates a state of an ad creation interface for selecting a product or service to use in a suggested ad for a user logged into the interpersonal electronic advertising system in accordance with the preferred embodiments.

FIG. 16 illustrates a state of an ad creation interface for previewing and sending a suggested ad for a user logged into the interpersonal electronic advertising system in accordance with the preferred embodiments.

FIG. 17 illustrates a state of ad creation interface for modifying or adding a payment destination in accordance with the preferred embodiments.

FIGS. 18 and 19 illustrate a state of ad creation interface for allowing merchant participation in accordance with the preferred embodiments.

FIG. 20 is a flow chart of a method for generating a suggested ad in an interpersonal electronic advertising system in accordance with the preferred embodiments.

FIG. 21 illustrates a network including an interpersonal electronic advertising system in accordance with the described embodiments.

FIG. 22 illustrates a sample computer system in accordance with the described embodiments.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As described herein, embodiments of interpersonal electronic advertising methods and systems leverage information provided from an intended advertisement recipient (or ‘intended recipient’, or ‘ad recipient’, or ‘recipient’) to an electronic advertisement suggester (or ‘ad suggester’ or ‘suggester’). The interpersonal electronic advertisement system enables the ad suggester to use information received from the ad recipient to select and send electronic advertisements, or ads, to the ad recipient. The system enables the ad suggester to be compensated when the recipient activates the ad.

An activation of the ad can involve the ad recipient completing a purchase associated with the advertisement. For instance, via a user interface, the ad recipient can select an ad created by the ad suggester. The ad can advocate a particular product or service. After selecting the ad, the interface can be reconfigured to allow the ad recipient complete the purchase. After the purchase is completed, the ad suggester can be compensated.

An ad suggester and an ad recipient can have a relationship that involves the sharing of current and trusted consumer information. For instance, the ad recipient may tell the ad suggester that they wish to purchase a particular product or service in the near future. With this knowledge, the ad suggester can use the interpersonal electronic advertising system to create and send timely and relevant ads to the recipient, which have a high likelihood of action by the recipient. It is believed that in many situations the likelihood of action by the ad recipient, such as purchase resulting from a received ad, will be much higher than current electronic advertising systems. With higher likelihood of action, the ad suggester can be compensated at a much higher rate than current electronic advertising systems afford.

As mentioned in the previous paragraph, via their interpersonal communications an ad suggester within the system can receive consumer information from a potential ad recipient. The ad suggester can use the consumer information as a basis for creating or selecting and sending suggested ads (or ‘interpersonal ads’) to an ad recipient. The interpersonal communications can involve direct, face-to-face communications or electronic methods, such as voice, instant messaging, text, email, or twitter feed, where an electronic device is employed to enable the communication. As an example, in a text or in a face to face conversation an ad recipient can tell the ad suggester that they desire to purchase a product or service in the near future. In other instances, the ad suggester can also obtain consumer information associated with the ad recipient by indirect methods. For example, the ad suggester can obtain consumer information associated with the ad recipient through observation of preferences expressed in previous purchases made by the ad recipient or through the observation of the ad recipient's interaction with other individuals besides the ad suggester. In either case, the ad suggester now has personal and intimate and timely consumer information relating to a consumer need for the ad recipient.

Using the consumer information, the ad suggester can use the system described herein to create an electronic advertisement for provision to the ad recipient. For example, a man tells his cousin that he is planning a trip and needs to purchase new luggage. This is sufficient information for the cousin to use the interpersonal electronic advertising system to create or select and send the man an advertisement featuring a particular brand and model of luggage. The cousin may select the particular brand and model based upon additional consumer information the cousin knows about the man, such as how much he typically spend on items, whether he tends to pack a lot, suitable price range, or what type of luggage the man prefers. The man can favorably receive the ad because 1) it arrives from a trusted source, 2) it arrives in a timely manner, and 3) it is personalized to him and his preferences and 4) the man might be aware the cousin will be compensated if he purchases the luggage via the ad provided through the system.

In contrast to the system described in the previous paragraph, current context based electronic advertising systems are much less accurate with respect to the man's consumer desires. For instance, the man in the example above might do a search related to his upcoming trip. In response, a context based advertising system might serve up an ad related to travel products. A number of travel product suppliers may bid to have their ad shown first to the man, including airlines, hotels, etc even though someone else has already booked his hotel and flight. If a luggage provider is in the bidding and bids more than the hundreds of competing airline and hotel advertisers, then the man may see a luggage advertisement. Thus, in a context based advertising system, the odds of providing a timely and on-point ad to the man, such as an ad targeting a desired consumer need of the man that has not already been fulfilled is likely to be much lower than with the systems and methods described herein.

Further, because of the inaccurate and untimely nature of current context based electronic advertising systems, a high proportion of electronic ads displayed to a user of such systems are irrelevant. This conditions a person to generally ignore ads. Thus, the likelihood of acting on future ads is also diminished. It is believed with the interpersonal electronic advertising system described herein ads of a more relevant nature will be delivered more consistently than other electronic advertising systems. Thus, it is believed participants in the interpersonal electronic advertising system won't engender as much of the negative conditioning that occurs with other electronic advertising systems.

In some implementations, the interpersonal electronic advertising system can include one or more servers coupled to a network. An individual can access the server via one of their personal electronic devices, such as a home computer or mobile device. The individual can be added to the system via a registration process where the individual provides identification information and is assigned an account. After obtaining an account, the new user can begin sending suggested ads to ad recipients. The ad recipients can be users and non-users (not registered) of the system. Based on the activities of the ad recipients that have received their suggested ads, such as purchases resulting from the suggested ads, the new user can be attributed compensation. During registration the new user can include payment information, such as bank account information, that allows them to receive the attributed compensation.

To enable the generation of suggested ads, the server can be configured to generate an ad creation interface for a user. The ad creation interface can be generated on various types of devices, such as smart phone, tablets, laptop and desktop computers. Via the ad creation interface, the server is configured to receive electronic advertisement input (or a ‘suggestion’) from the user (ad suggester). In response to the input, server can generate advertisement (a “suggested ad”). The suggested ad can include a name of the person that has provided the input to generate the ad. After the suggested ad is created, the server can send the suggested ad to a designated ad recipient.

In a particular embodiment, the ad creation interface can include three tabs, a “who” tab, a “what” tab and a “send” tab. The interface can be configured such that each of the tabs is expandable or collapsible. A selection of the “who” tab can cause the tab to expand. Via the “who” tab, input identifying or related to an ad recipient can be entered. If a sign in procedure for logging into a valid account has been completed, the input may be entered via a selection of a contact previously entered by the logged in user. The contact can include a first name, a last name and/or other contact information, such as an e-mail address, of the intended ad recipient. If a sign in procedure has not been completed, the interface can be configured to receive a first name, last name and contact information via an input mechanism, such as keyboard or touchpad.

A selection of the “what” tab can cause the “who” tab to collapse and the “what” tab to expand. Data can persist from one tab to another tab. Thus, information entered in the “who” tab can be automatically associated with information entered in the “what” tab. Also, if data is entered via the “what” tab and the user subsequently goes back to the “who” tab and enters new information, such as a new ad recipient, then the new ad recipient can be automatically associated with the data input and/or generated within the “what” tab.

In the “What” tab, an individual can search for a particular product or service. The interface can be configured to accept one or more search terms and a specification of a product category, such as electronics or books. If the search returns multiple items, the user can select one of the items and a preview of the selected item can be output. The preview can include a commission amount the user can earn, a picture of the selected item and details of the selected item. In another embodiment, a user can specify a URL (universal resource locator) where an advertisement for a particular product can be found. The system can be configured to locate the advertisement on the page specified by the URL, retrieve information related to the advertisement and generate a preview of the product included in the advertisement.

Next, the “send” tab can be selected and the “what” tab can be collapsed. An image of a suggested ad for a product that was selected via the “what” can be displayed. The suggested ad can include a name of the individual that is sending the suggested ad, a logo for a system operator, an image of a product, a product description, a selectable link that causes further details of the product to be displayed and a selectable link that causes an interface to be displayed from which a purchase can be initiated. The “send” portion of the interface can be configured to accept a short personal message from the ad suggester and a send button. A selection of the send button can cause the suggested ad and any personal message specified to be sent.

In particular embodiments, the ad creation interface can include links to a user registration interface, a merchant registration interface and a dashboard interface. The registration interface can be configured to accept input that allows a new account with the system to be generated. The merchant registration interface can be configured to accept input that allows a merchant to have their products or services utilized within suggested ads generated by the system. The dashboard interface can be configured to output information that allows a registered and logged in user to monitor their ad activities within the system.

One aspect of the embodiments described herein is related to a method in an interpersonal electronic advertising system. The method can be generally characterized as comprising: 1) controlling output in a processor of an electronic ad creation interface; 2) displaying via the interface a commission amount, a product, a product description and a merchant through which the product can be purchased for a selected electronic ad; 3) receiving via the interface an ad recipient for selected electronic ad; and 4) displaying via the interface an image of the selected electronic ad, said image including a name of a person that has selected the electronic ad, an image of the product, a price of the product, a merchant's name and an indicator of a mechanism for initiating a purchase of the product.

Techniques and methods described herein can find use with a wide array of electronics devices. For example, desktop and laptop computers are now common and may implement software that permits users to select and send and receive ads. Electronic interpersonal advertising as described herein is also suitable for use with mobile electronic devices such as personal digital assistants (PDAs), cellular telephones, smartphones, portable computer systems, thin clients, portable tablet computers, audio players, among others, because of the inherent portability of such devices.

All or portions of the subject invention may be implemented as a method, apparatus, system or article of manufacture using programming and engineering techniques to produce software, firmware, hardware or any combination thereof to control an electronic device to implement the present invention. The term “article of manufacture” as used herein is intended to encompass a computer program with executable instructions accessible from any computer readable device, carrier, or media. For example, computer readable media can include but is not limited to magnetic storage devices, optical disks, smart cards, flash memory devices among others. Of course, those skilled in the art will recognize many modifications may be made to this configuration without departing from the scope or spirit of the disclosed invention.

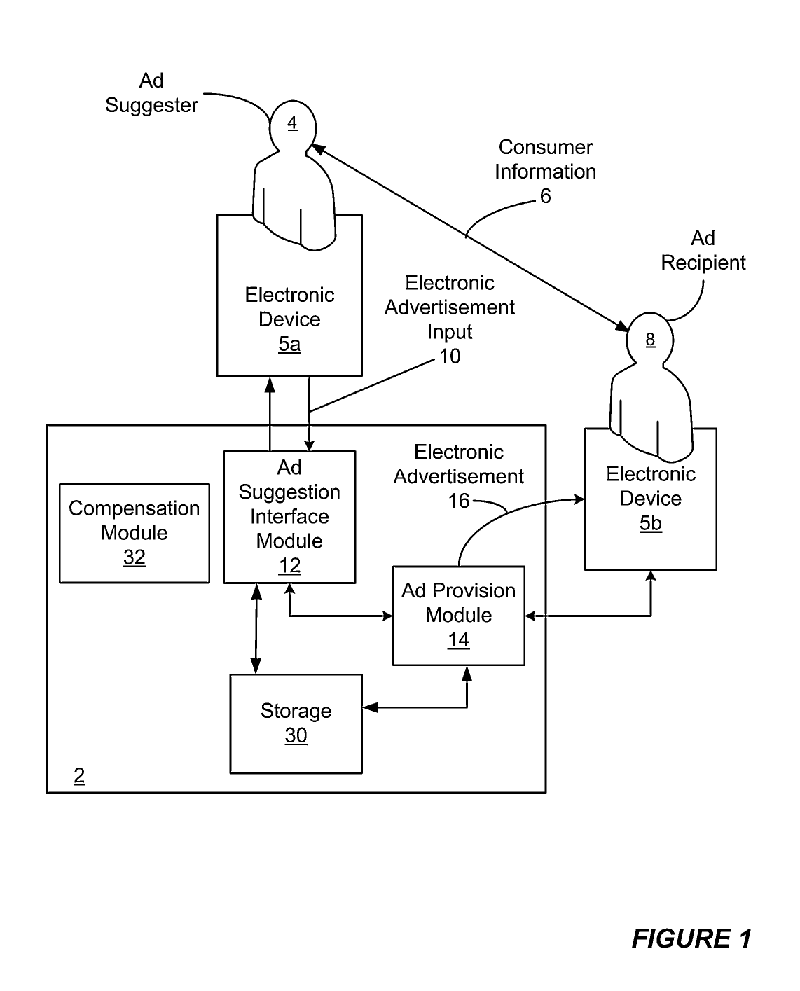

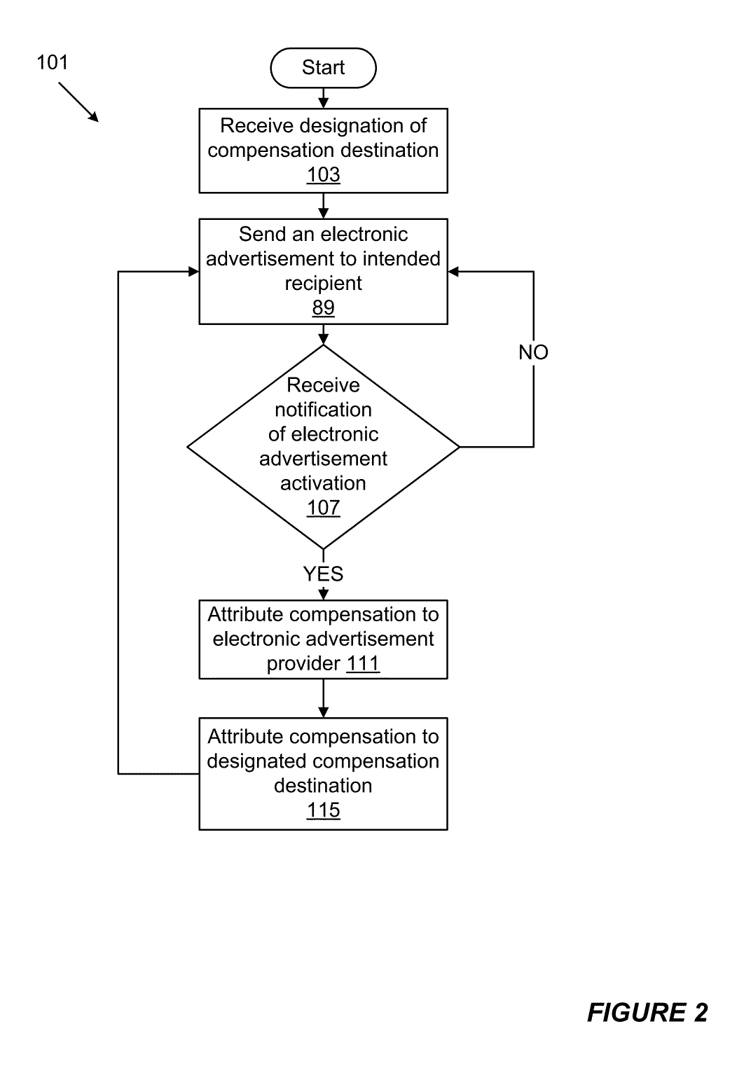

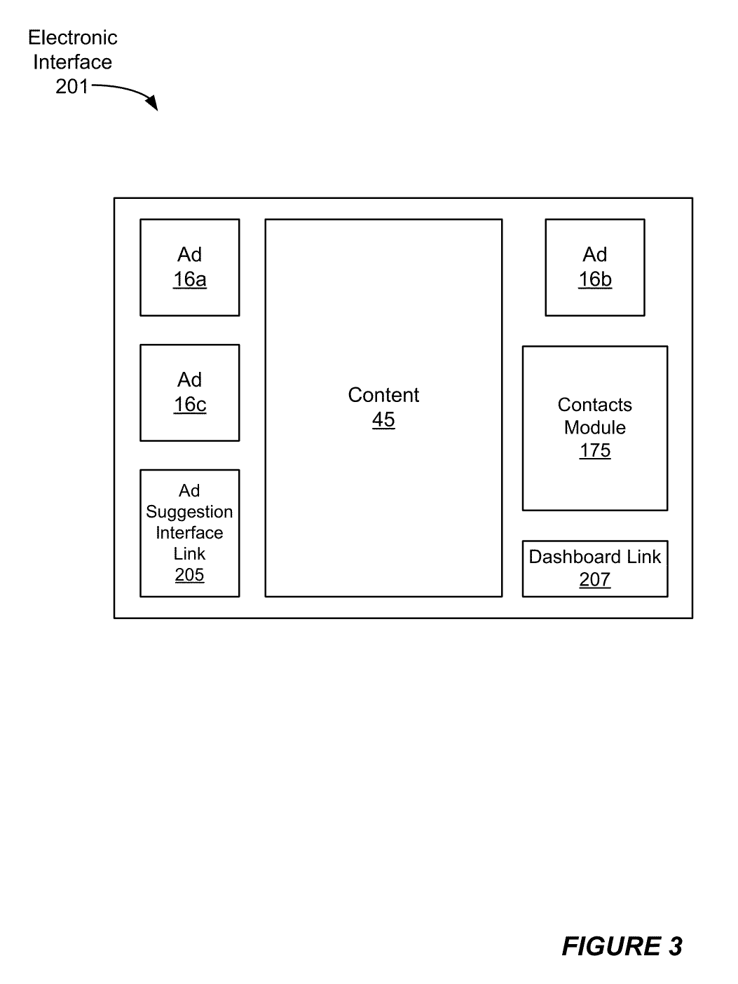

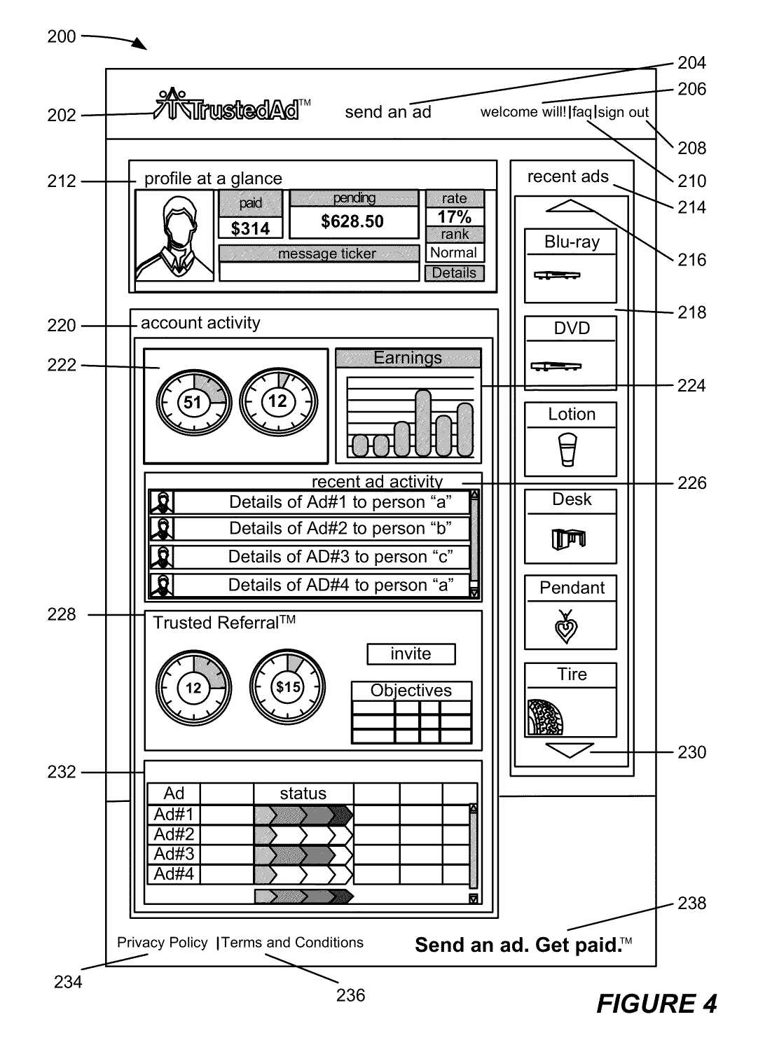

An interpersonal electronic system including an ad creation interface that allows a user to generate suggested ads is described with respect to the following figures and sections. In particular, an overview of the interpersonal advertising system is described with respect to FIGS. 1 and 2. In particular, consumer information, selecting and sending suggested ads based upon the consumer information and compensation for sending suggested ads that result in a purchase by an ad recipient are described. In addition, methods for determining various ad suggestion effectiveness metrics for an ad suggester are described. With respect to FIG. 3, one example of an interface that allows an ad recipient to view suggested ads is described. An arrangement of a dashboard interface is discussed with respect to FIG. 4. The dashboard interface can be configured to allow a user to monitor their activities within the interpersonal electronic advertising system. Further, dashboard interface can be configured to output a list of suggested ads sent to the user and/or a list of suggested ads sent to other individuals by the user.

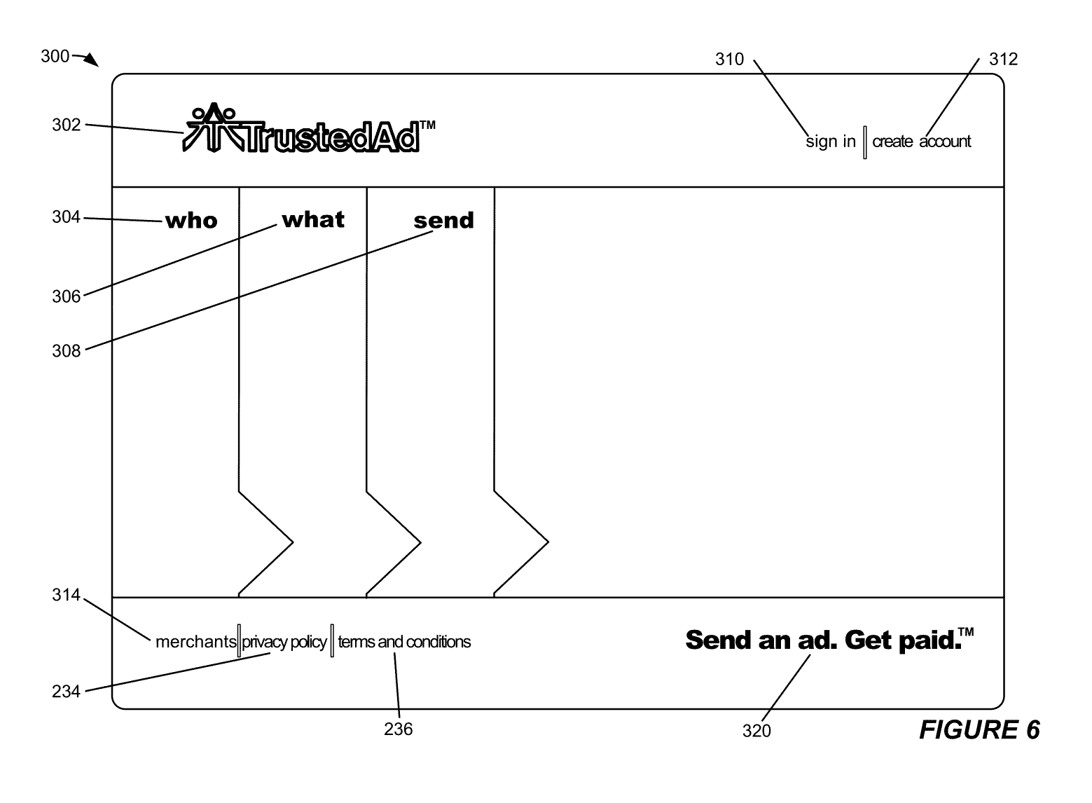

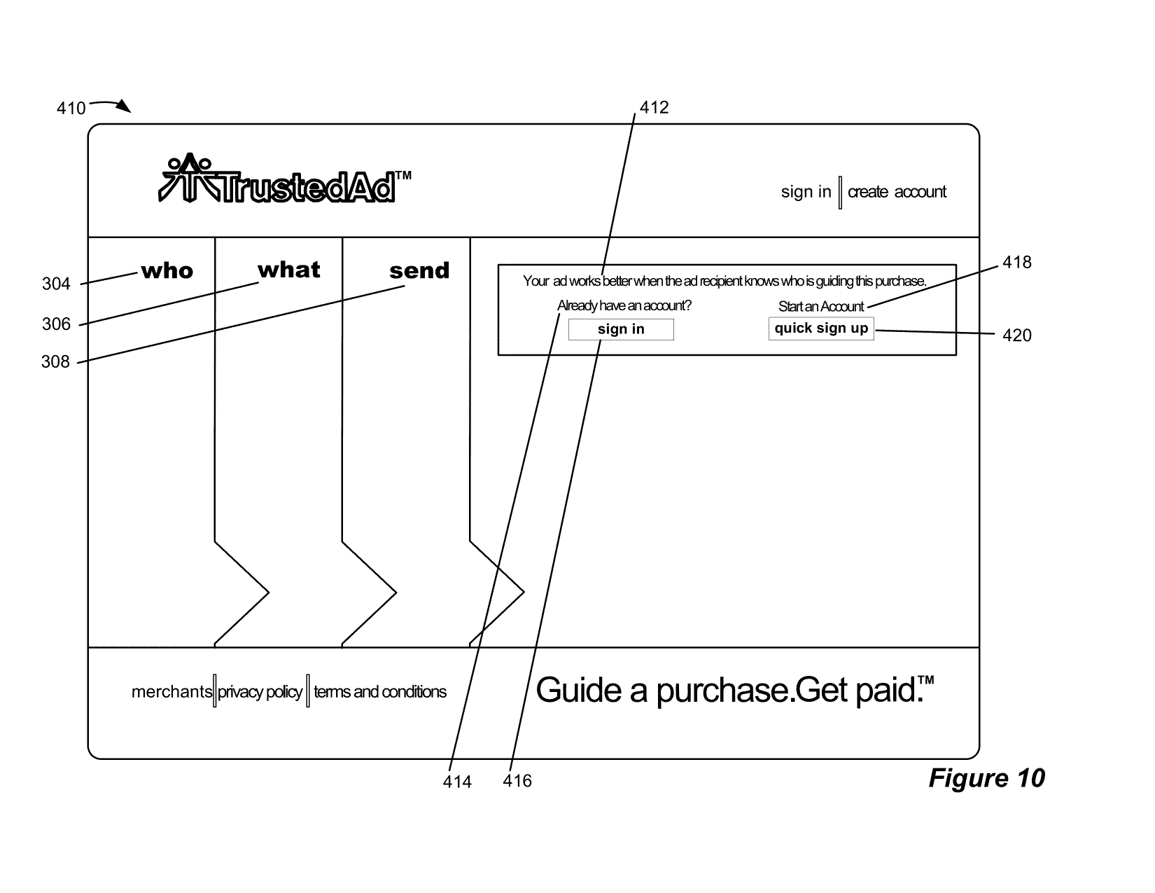

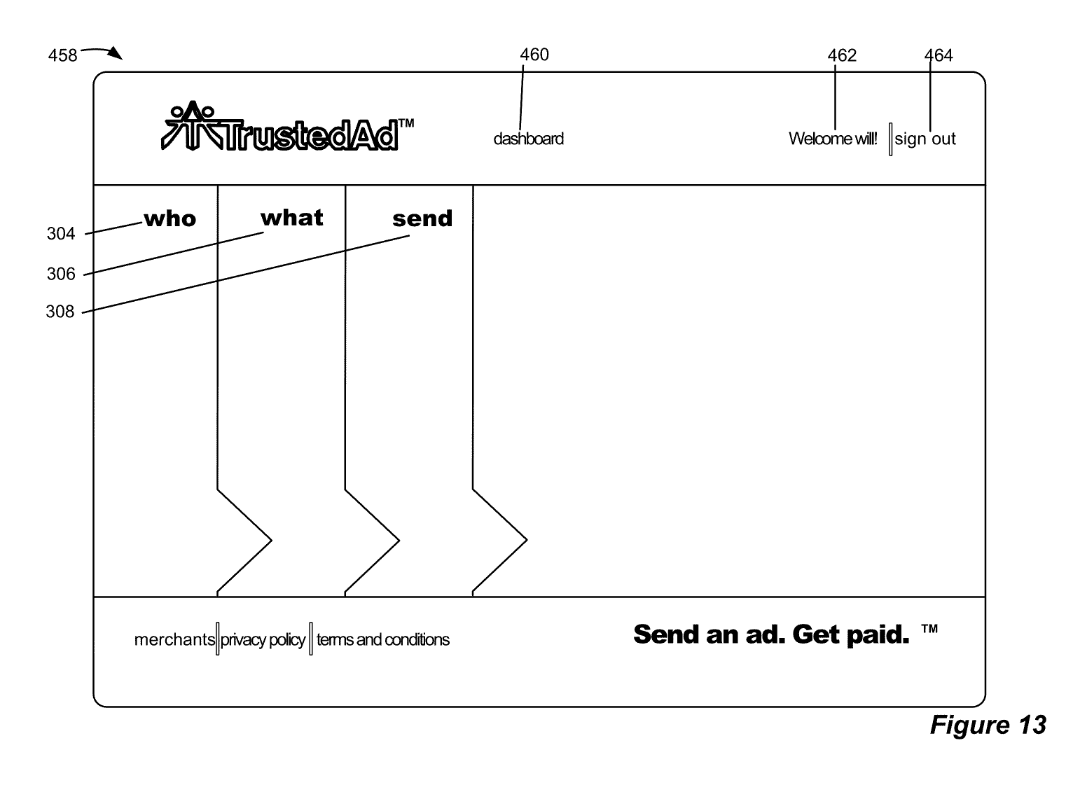

With respect to FIGS. 6-9 a portion of an ad creation interface that can be accessed prior to generating a user account or logging into the interpersonal electronic advertising system is described. Via this portion of the interface, the process of generating a suggested ad can be initiated. A portion of the ad creation interface for initiating user registration or logging a registered user into the system is described with respect to FIGS. 10-12. With respect to FIGS. 13-17 a portion of the ad creation interface that is generated after creation of an account and a valid login to the account are discussed.

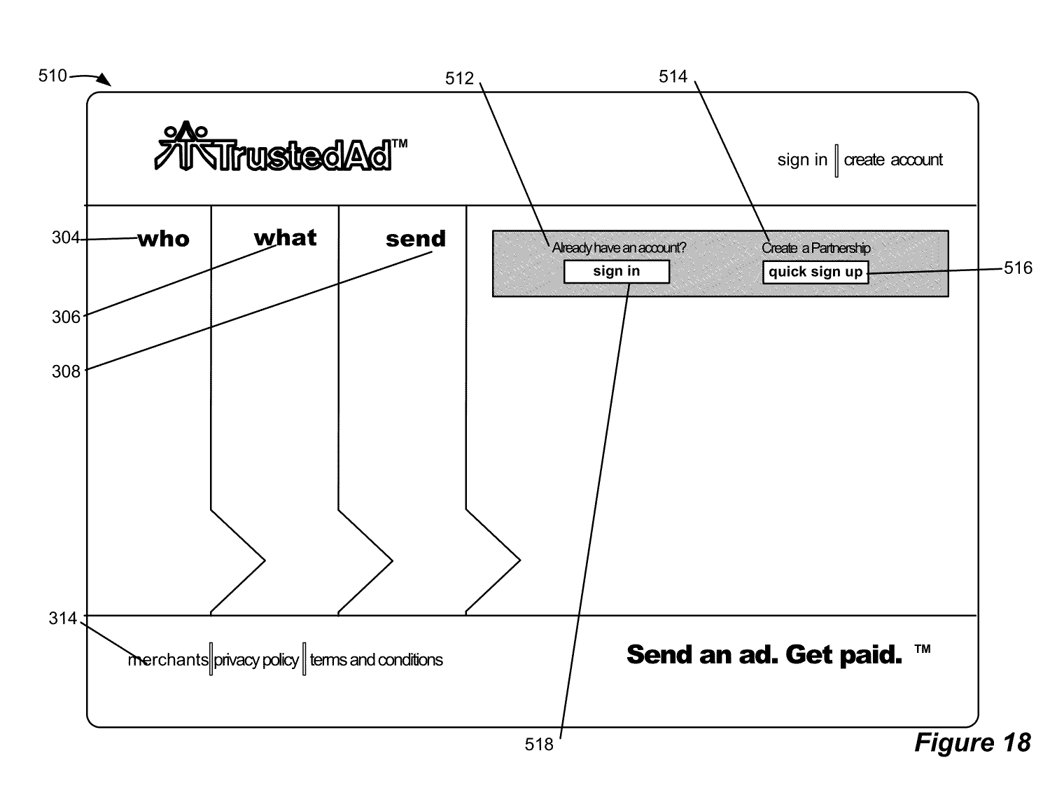

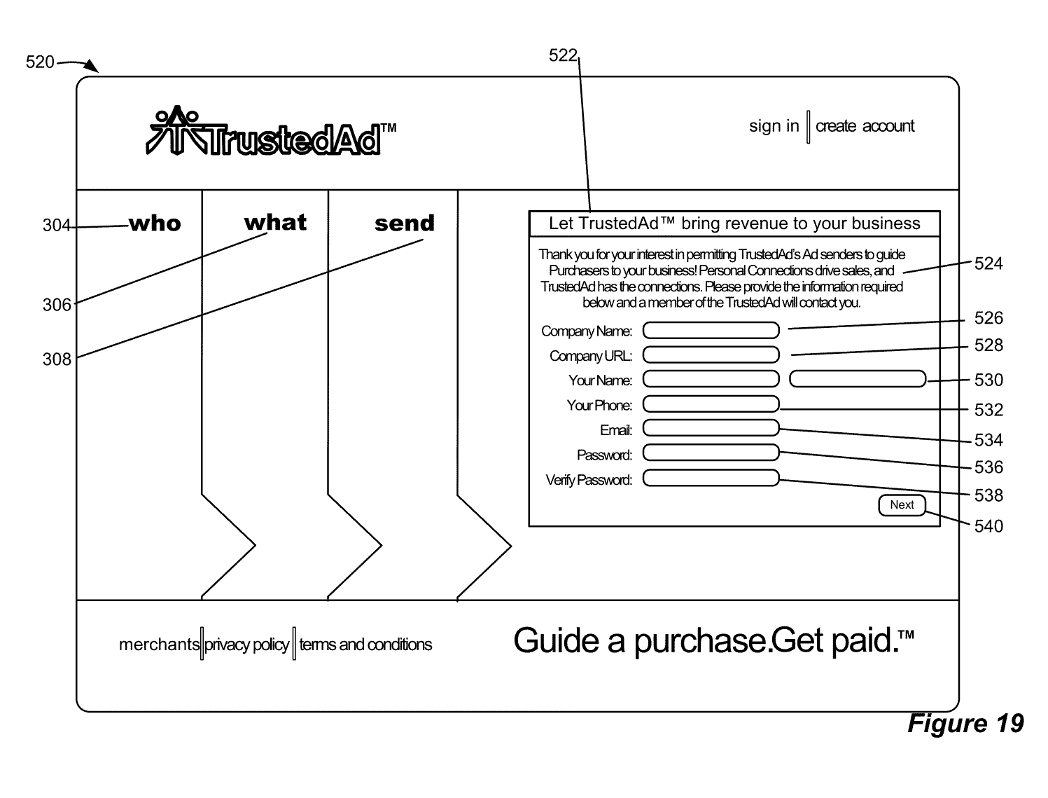

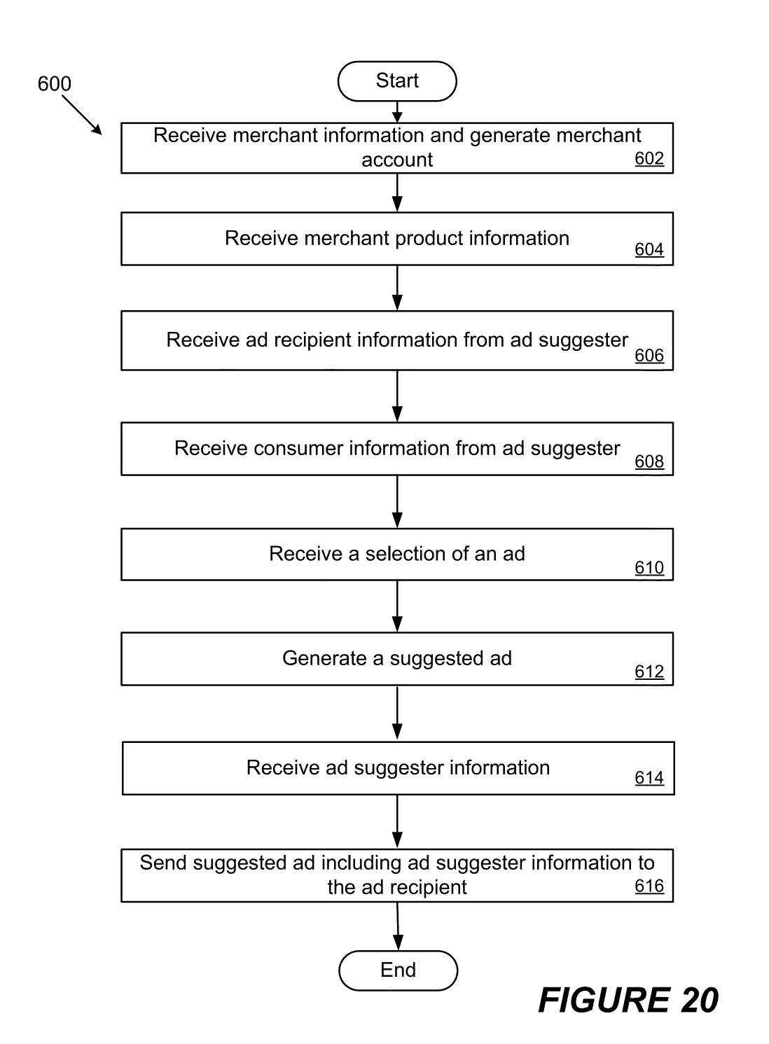

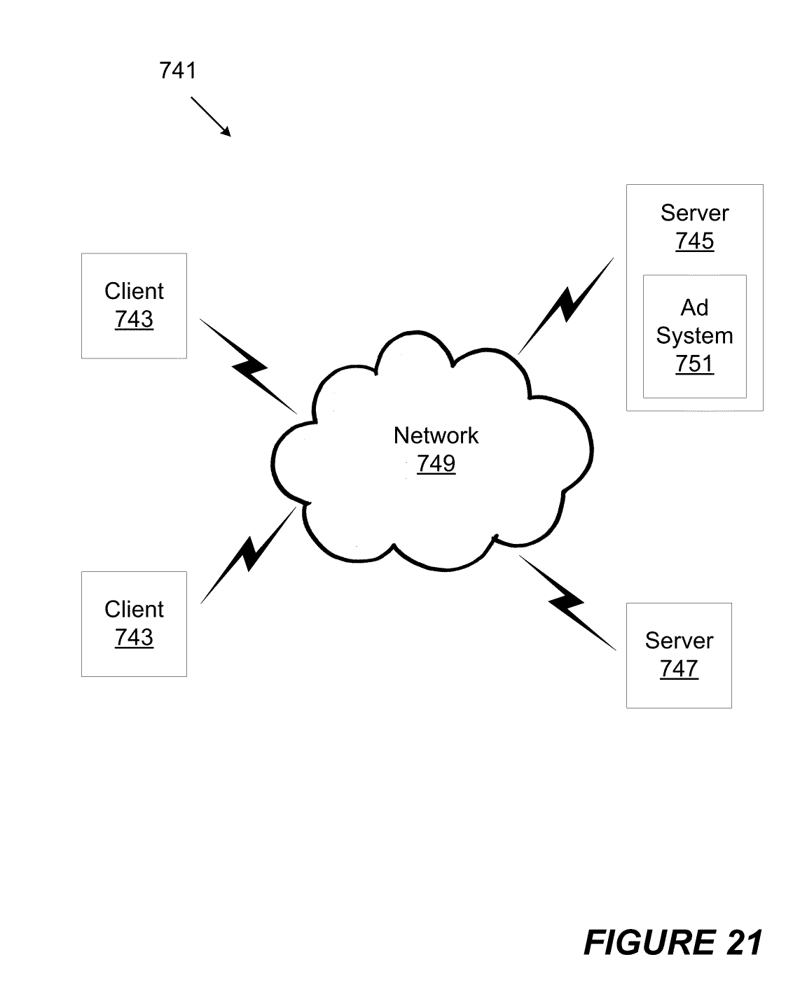

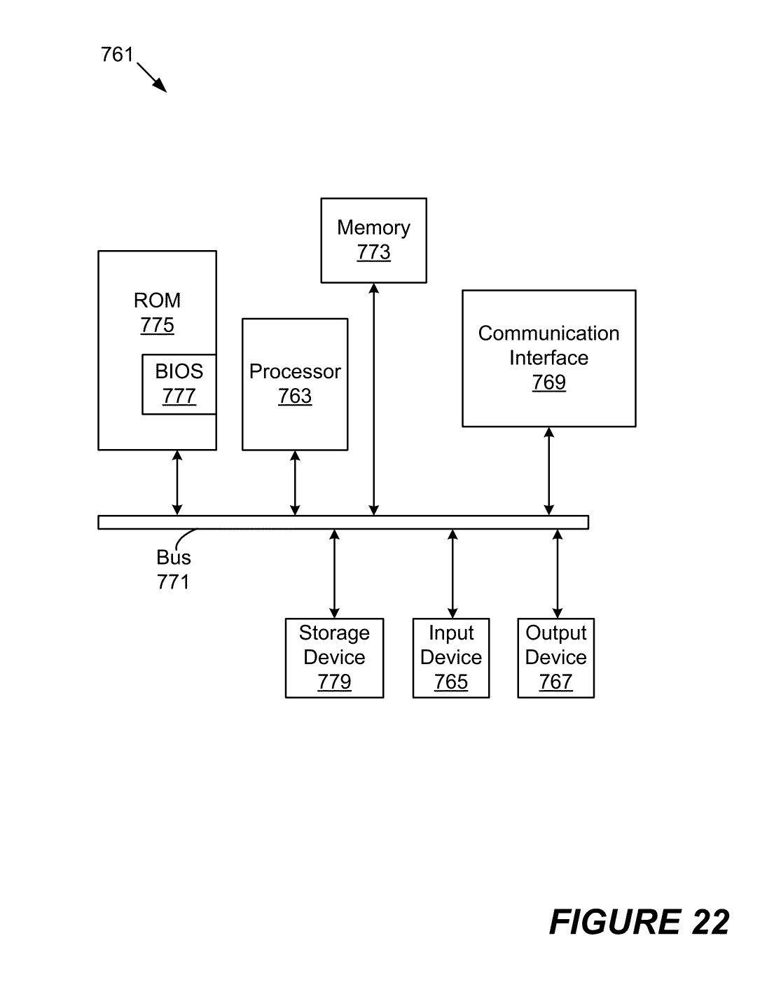

A portion of the ad creation interface that allows a merchant to interface with the system is described with respect to FIGS. 18 and 19. With respect to FIG. 20, a method of generating a suggested ad in an interpersonal electronic advertising system is described. Finally, system and system components that can be utilized in an interpersonal electronic advertising system are described with respect to FIGS. 21 and 22.

### Interpersonal Electronic Advertising System

FIG. 1 illustrates a system 2 for sending electronic advertisements in accordance with one embodiment. System 2 includes an advertisement suggestion interface module 12, ad provision module 14, storage 30 and compensation module 32. The system 2 can be configured to interact with numerous electronic devices, such as 5a and 5b. In the example in FIG. 1, electronic device 5a is controlled by an ad suggester 4 and electronic device 5b is controlled by an ad recipient 8.

As described in more detail below, the ad suggestion interface module 12 can relate to system components that allow an ad suggester 4 to create an advertisement 16. Whereas, the advertisement provision module 14, or ad provision module 14 can refer to any device, system or tool within system 2 configured to send ad 16 to intended ad recipient 8. Data storage 30 can include hardware and/or software for storing information related to system 2. Typically, when the ad suggester 4 selects and sends an ad that leads to a purchase by the ad recipient, compensation is attributed to the ad suggester 4. Compensation module 32 can be configured to attribute an incentive or compensation within interpersonal advertising system. Compensation can refer to any type of incentive, whether monetary, or in another form such as a discount on a present or future consumer transaction, coupon, merchandise, award, products, services, electronic tokens, virtual currency, rebate, among others.

During operation, the system 2 can be configured to interact with a various numbers of electronic devices where the number of electronic device interacting with the system can vary over time. The system 2 can provide different functions to each of the electronic devices and the functions provided to each device can change over time. For instance, at a first time, individual 8 can engage with system 2 as an ad recipient via device 5b. At a later time, individual 8 can engage with the system 2 as an ad suggester via device 5b. In FIG. 1, for the purposes of illustration, individual 4 is referred to as ad suggester 4 and individual 8 is referred to as an ad recipient 8. However, as noted, at different times the ad suggester 4 can engage system 2 in the role of an ad recipient and the ad recipient 8 can engage the system 2 as an ad suggester.

The system 2 can be configured to establish communication connections with electronic devices, such as 5a and 5b. Via the communication connections, information can be exchanged between the electronic devices and system 2. For example, via device 5a, ad suggester 4 can select and transmit electronic advertisement input 10 to system 2. Further, an ad recipient 8 can view an electronic advertisement 16 suggested by the ad suggester 4 which the system 2 has routed such that it can be viewed on device 5b.

In this depiction, an electronic advertisement suggester 4 (also referred to herein as ad suggester 4, or suggester 4) can refer to any person that possesses consumer information 6 regarding an intended ad recipient 8. Whereas, intended electronic advertisement recipient 8 (also referred to herein as intended recipient 8, or intended electronic advertisement recipient 8, or intended ad recipient 8, or recipient 8) can refer to an intended recipient of a suggested electronic advertisement generated on system 2, such as 16. The advertisement suggester 4 can interact with the system 2 via a client device, such as device 5a to select ads, such as 16, intended for receipt by the ad recipient 8. Thus, the selected ads are suggested ads for the intended ad recipient 8 by the ad suggester 4. Ads created in this manner are referred to as suggested ads.

The ad recipient 8 can interact with the system 2 via client device, such as device 5b, to receive the electronic advertisements suggested by the ad suggester 4, such as 16. Suitable electronic devices that can be utilized by the ad recipient 4 or the ad suggester 8 can use to interact with system 2 include but are not limited: a portable phone and/or phone number, a mobile device, a tablet, a thin client, a laptop computer, a netbook computer, a portable music player, a television, a cable display device, a desktop computer or any other electronic device configured to send and receive electronic transmissions or communications.

Data storage 30 can include hardware and/or software for storing information related to system 2. Data storage 30 can store information relating to the suggestion or provision of electronic advertisements. In specific embodiments, data storage 30 can include information relating to one or more of: a) a listing of advertisements 16, b) an entity that is related to each advertisement, c) suggesters 4, d) intended recipients 8, e) advertisement suggestion interface module 12, f) advertisement provision module 14, g) pointers to other websites or data locations that have products or advertisements, h) electronic advertisement input 10 and combinations thereof. Data storage 30 may include a database, a table, local hard disk memory, one or more RAM devices, memory available with conventional cloud computing techniques, or any means for storing information. In a specific embodiment, data storage 30 uses a relational database such those provided by Oracle Corporation of Redwood City, Calif. In another specific embodiment, data storage 30 employs an online database service, or Database-as-a-Service, (DaaS), such as those available from Microsoft Corporation of Redmond, Wash., or Amazon.com, Inc. of Seattle, Wash.

Within the system 2, the activities of both the ad suggester 4 and the ad recipient 8 can be tracked. In some instances, users of the system can be assigned one or more digital identifiers and the tracked activities can be associated with these one or more digital identifiers. In some embodiments, the system 2 can be configured receive information, such as a login and a password, that allow a user's identity to be verified and digital identifiers associated with the user to be located. After verification, activities performed by the user can be tracked and associated with their digital identifiers. Tracking information gathered by the system 2 can be stored to storage 30.

In one embodiment, the system 2 can store device information that is associated with an individual, such as the ad suggester 4 or the ad recipient 8 to storage 30. The device information can be associated with the individual when the individual regularly controls the device to interact with the system 2. Thus, when the device information for a particular device is detected, the system 2 can be configured to determine whether the device is associated with a particular individual. When the device is determined to be associated with a particular individual, activities performed using the device, such as 5a or 5b, can be associated with the individual. For instances, ad suggester 4 can register information about device 5a with the system 5a. When the system 2 detects device 5a, such as when a communication session is initiated with the device, the system 2 can determine device 5a is associated with ad suggester 4. Then, the system can be configured to attribute subsequent activities involving the system 2, such as an ad selection performed via device 5a, to ad suggester 4.

In particular embodiments, portions of the system 2 can be embedded in other systems. For instance, an ad suggestion interface module 12 can be integrated into a social media platform where the module 12 communicates with a remote ad provision module 14 in system 2 to provision ads to ad recipients. In this example, system 2 might also include its own ad suggestion interface module 12 separate from the embedded ad provision module. In another example, all the components of system 2 can be embedded in another system, such as a system associated with a social media platform. Many such configurations are possible and the example in FIG. 1 is shown for the purposes of illustration only. Further, functions attributed to each module can be combined or broken out in different manners and then the abstraction shown in FIG. 1 which is provided for the purposes of illustration only.

### Consumer Information in an Interpersonal Electronic Advertising System

As described above, an ad suggester, such as 4, can receive consumer information 6 from an intended ad recipient 8. As the term is used herein, consumer information 6 can refer to information relating to but not limited to a shopping need, recipient desire, a potential purchase, a recipient preference, an upcoming event associated with the recipient or a current or future location of the recipient. Examples of consumer information 6 include but are not limited to a) a product or service, b) price information, c) location information for recipient 8 or a store offering a product or service of potential worth to recipient 8, d) personal information related to a purchase such as a time or place of purchase, e) specific or approximate or general product and/or service information, etc. In a specific example, ad suggester 4 has knowledge that a friend recently purchased a house and wants to purchase a garage door opener that fits a garage door in the house. Consumer information 6 in this instance can include the knowledge of the friends recent house acquisition, their desire to purchase a garage door opener for his garage door, and maybe specifics on the garage door or when the recipient intends to purchase the garage door opener.

Consumer information 6 can be received directly or indirectly. The direct or in-direct communications of consumer information from recipient 8 to ad suggester 4 can involve non-electronic methods, electronic mechanisms, and combinations thereof. Non-electronic methods can include but are not limited to face to face conversations, a written note or observations of past purchases made by the recipient 8. A face to face conversation between the ad suggester 4 and the ad recipient 8 can result in a direct transmission of consumer information 6. Whereas, the ad suggester 4 can observe past purchases made by the ad recipient 8 to obtain consumer information 6.

Electronic mechanisms suitable for use herein, such as for a transmission of consumer information 6, can include a voice conservation enabled by an electronic device, an electronic message such as a text message or email from intended recipient 8 to suggester 4, a twitter feed from intended recipient 8 to suggester 4, one or more portions of an online chat conversation, one or more social networking posts, among others. For each of the electronic examples, an electronic device, such as a server, typically relays the consumer information 6 between the recipient 8 and suggester 4, and transmits the consumer information 6 to suggester 4. A direction electronic communication of consumer information 6 from ad recipient 8 to ad suggester 4 might involve the ad recipient 8 expressing a desire to purchase an item in a text message. An indirect electronic communication of consumer information 4 might involve ad recipient 8 posting a consumer need to person different from the ad suggester 4 and the ad suggester 4 viewing the post to obtain the consumer information 6.

As shown in FIG. 1, the transmission of consumer information 6 can occur via a communication channel outside of system 2. For instance, electronic device 5a and electronic 5b can enable voice communications between the ad suggester 4 and ad recipient 8 where the communications take place outside of system 2. In other embodiments, the system 2 can be configured with communication functions. For instance, system 2 can provide a chat function that allows the ad suggester 4 and the ad recipient to communicate and transfer consumer information 6. Thus, in some embodiments, although not shown, the consumer information 6 can be routed through system 2.

In more detail, as noted above, the ad suggester 4 can directly or indirectly receive consumer information 6 from the ad recipient 8. Indirect methods can involve observations that occur during the interactions or visits to the places where recipient lives or works. For instance, an ad suggester, such as 4, may notice that an ad recipient, such as 8, uses a particular product, such as a particular brand of shoes or a brand of a purse. Later, the ad suggester 4 may learn via a face-to-face conversation that the intended recipient is looking for a new purse or shoes. Based upon the consumer information they have indirectly learned, i.e., the ad recipient 8 may have never told the ad suggester 6 directly about the brand of purse they prefer, and the consumer information they have directly learned, the ad suggester 4 may select an ad for the ad recipient 8 via system 2.

As another example, an ad suggester 4 can obtain consumer information 6 when the ad suggester visits the ad recipient's 8 home. The recipient 8 may not even be present. While visiting, the ad suggester 4 may notice things about certain purchases the ad recipient 8 has made in the past. The observations the ad suggester 4 has made may later server as consumer information 6 when the ad suggester 4 is selecting an ad, such as 16, for the ad recipient 8. In yet another example, the ad suggester 4 can overhear a conversation the ad recipient 8 is having with another individual (e.g., the ad suggester 4 and ad recipient 8 can live together with other individuals) and learn consumer information 6. Thus, through interactions that occur over time, an ad suggester 4 can be directly or indirectly gathering consumer information 6 from the ad recipient 8.

In other embodiments, consumer information 6 can relate to third-parties, such as individuals or groups known by the ad suggester 4 or ad recipient 8. For instance, if the ad recipient 8 is intending to purchase an item for another individual, consumer information 6 can include information about the individual that is to receive the purchase and/or information about the ad recipient 8. If the ad recipient 8 is intending to purchase an item for a group, the consumer information 6 can include information that the ad suggester 4 knows about the group and/or ad recipient 8.

In a father/son jewelry example, a son (ad suggester 4) can have knowledge that his father (ad recipient 8) has not purchased an anniversary present for the son's mother (third party, not shown). Consumer information 6 that the son possesses may include one or more of: i) information about an upcoming wedding anniversary, ii) specific jewelry product information that mother prefers, iii) the father's current location, iv) an anticipated price range, v) that father wants to do something nice for his mother, such as buy her jewelry, vi) other types of gifts the father has bought the mother on similar occasions or vii) combinations thereof. Thus, in this example, the consumer information 6 known by the ad suggester 4 (son) is related to the ad recipient 8 (father) and additionally a third-party (mother).

As described above, a relationship between suggester 4 and intended recipient 8 can improve intended recipient's 8 reception of advertisement 16. Depending on the relationship between 4 and 8, the intended recipient may activate ads, such as 16, at a higher rate as compared to ads received from other individuals or ads generated from non-trusted context-based electronic advertising systems. After the ad recipient receives an ad from the ad suggester 4, activation of the ad can involve the ad recipient using system 2 to view the ad 16, select the ad 16, or purchasing a product or service based on ad 16. As is discussed more below, the purchasing of a product or service based on ad 16 can result in compensation for ad suggester 4 via compensation module 32.

In more detail, a perception of trustworthiness can exist between the two people interacting with system 2, such as 4 and 8. When the person 8 knows that certain consumer information 6 was given to suggester 4 in a trusted communication, person 8 then may expect ad 16, or welcomes the ad based on its trusted source. An ad provided to ad recipient in this manner may be much better received than an ad, such as 16, from a non-trusted source, such as a business that the person 8 has no history of prior interaction, knows very little about the person 8 and has paid a search service the most money for an ad spot. Systems and methods described herein however enable intended recipient 8 to receive an electronic advertisement 16 from a known suggester 4. It is believed that factors, such as the trust between the ad recipient 8 and ad suggester 4 and consumer information 6 possessed by the ad suggester 4 that was ideally used in selecting an ad for the recipient 8, increase the likelihood that intended recipient 8 views and acts on the advertisement 16 when system 2 is employed.

The system 2 can be configured to receive electronic advertisement input generated on an electronic device, such as 5a. An interface, such as an interface implemented via a web-browser or a client application executing on the electronic device can be used to provide the electronic advertisement input 10 to system 2. In one embodiment, the ad suggestion interface module 12 can be configured to generate an interface on an external electronic device, such as 2, via a client application such as a web-browser. The electronic advertisement input 10 can include data related to an ad recipient 8, such as information that allows a suggested ad to be sent to the person, consumer information 6, and/or advertisement selection received by ad suggestion interface. The ad suggester 4 may use the interface to locate an ad associated with a particular product or service provider accessible on system 2. Thus, electronic advertisement input 10 can include information related to one or more of a company, a person, an entity, a vendor, a product, or a service.

The consumer information 6 can be reflected in a creation or selection of an advertisement within the system. In addition, the system may allow a user, such as 4, to store consumer information 6 associated with particular individuals, such as anniversaries and product preferences. In one embodiment, this information can be stored in storage 30. Consumer information 6 entered as electronic advertisement input 10 can be stored and later retrieved when the ad suggester 4 subsequently interacts with the system 2.

### Ad Suggestion and Ad Provisioning in an Interpersonal Electronic Advertising System

As described above, the ad suggestion interface module 12 can support a GUI that allows suggester 4 to create and suggest an ad using their consumer information 6. The GUI can be configured to allow the user to view and select various ads that can be sent to the ad recipient 8. Businesses associated with these ads can have agreed to send compensation to system 2 when an ad from system 2 has resulted in a purchase. In one embodiment, the system 2 can be configured to notify a business when an ad associated with the business has been suggested by an ad suggester 4 for an ad recipient 8. The notification message can include information that identifies the ad as having been suggested using system 2. This information may allow the business to keep track of potential transactions that can result in compensation being sent to system 2.

In particular embodiments, the GUI can be configured to allow a user to select an advertising entity or vendor, such as a business or store, which is not included in an existing set of advertisers. In such instances, suggester 4 can use the interface generated by 12 to identify the new advertising entity or vendor. In addition, the GUI can be configured to allow a suggester 4 to select, in addition to the new advertising entity or vendor, a specific product or service offered by the advertising entity or vendor. The selected product or service can be used to generate a suggested ad, such as 16. Once suggester 4 provides the electronic advertisement input 10 using the advertisement suggestion interface module 12, the system 2 can be configured to send data communication to the advertising entity or vendor informing the advertising entity or vendor that an ad 16 will be created in an attempt to bring a customer to that business.

After receiving the communication, the advertising entity or vendor may decide whether to allow system 2 to provide the suggested electronic advertisement 16 to the intended recipient 8. An affirmative response from the advertising entity or vendor can result in electronic advertisement provision by the ad provision module 14 to the intended recipient 8. In addition, the affirmation may also include an agreement by the advertising entity or vendor to compensate for use of the service provided by system 2. Information regarding the affirmative response and/or compensation agreement can be stored to storage 30.

In a specific example of involving the utilization of system 2, a son 4 can possess consumer information 6 that his father 8 wants to purchase jewelry for a wedding anniversary 6. The son 4 can establish a communication with system 2 via electronic device, such as 5a, after which an interface associated with system 2 can be generated on device 5a. As described above, the ad suggestion interface module 12 can support the generated interface. The ad suggestion interface module 12 can be configured to support an interface that is suitable to the type of electronic device 5a that is being utilized. For instance, a different interface with different capabilities can be provided for a smart phone as compared to a laptop computer.

Via the generated interface, the son 4 can select and/or send one or more ads 16 for the father 8 indicative of his consumer information 6. The son may search for a specific piece of jewelry that he knows mom wants, or browse available options to find a product to suggest in an ad to Dad 8. In addition, via the interface, the son 4 may enter consumer information 6, such as the father's need of jewelry for the anniversary. The system 2 can be configured to store this information for data aggregation purposes.

In particular embodiments, consumer information 6 can include timely location information. For example, the son 4 may know where the father 8 is currently shopping, e.g., at a mall near their home. Based upon this consumer information 6, the son can select and/or suggests one or more ads 16 to the father 8 for local jewelry stores in that mall. For example, the suggested ad 16 can include a particular necklace that mom wants at a selected store. In another specific example, the suggested ad 16 can include a discount or coupon for use at a jewelry store specifically redeemable within a limited time period corresponding to their visit to the mall to entice recipient 8 to enter the store. The father 8 then may print out an ad 16 or coupon 16 or use a portable electronics device to present an electronic version of the ad 16 or coupon 16 (such as one electronically sent to the father and displayed on his phone that the participating store will honor) to redeem during a transaction at the advertising store when the father 8 arrives at the store.

In one embodiment, the son 4 can know information related to various modes of communication that the father utilizes, such as mobile device numbers, e-mail accounts, postal addresses, etc. The system 2 can be configured to receive and store this information as well as allow a user to select a specific mode of delivery for the suggested advertisement. For instance, knowing the father is in the mall and the father is most likely to look at an incoming email, the son 4 can utilize the system to send the email-based ad 16 at least to the father's smart phone. If desired, the system 2 can be configured to allow the son to send the message via multiple communications modes, such as the text message, an audio message delivered to the father's phone, banner ad, and/or an e-mail.

Besides sending the ad 16 directly to the father, other modes of allowing the father to view the ad are contemplated. In one embodiment, the system 2 can be configured to interact with a social media application that displays the son's profile page. The system 2 can be configured to display suggested ads to the son's profile page. When the father visits the sons profile page, the suggested ad 16 can be displayed to the father. In this manner, the father may learn about the detail. Further details of social media applications are described below with respect to FIG. 3.

After the ad 16 is sent and if the father 8 acts upon the ad 16, the system 2 can be configured (see FIG. 2) to allow the son 4 to be compensated directly or indirectly from a merchant or service provider where the father 8 made a purchase. The compensation module 32 can be configured to perform this function. As an example, a jewelry store associated with ad 16 can agree to pay a percentage of the purchase generated from ad 16 to system 2, such as 10% of the purchase. After receiving the money from the jewelry store (or immediately, depending on the relationship between the store and the system 2), the son can be paid some portion of the money. The participating store pays such advertising fees since, without the son's help and timely advertising input 10, the store might not have made this particular sale to the father 8. At the least, the ad 16 alone may be enough to draw the father 8 into their store—first and before he visits the other three stores in the mall. If it is determined the father 8 was drawn to the store as a result of receiving the ad 16, in some embodiments, the ad suggester 4 can be compensated in some manner even if a purchase isn't made. Compensation of ad suggester 4 is described in further detail below.

As described above, an interface supported and/or generated by module 12 can receive electronic advertisement input 10 entered by ad suggester 4. Again, suggesting an ad can refer to the process of providing input 10 that at least partially determines ad 16 including receiving specific input that leads to the selection of a specific ad 16. Using ad suggestion interface module 12, suggester 4 can provide input 10 that may include or more of: i) information related to the results from searching for an ad related to consumer information 6, ii) information related to the selection of an ad 16 from a list, ii) information related to identification of one or more recipients 8 for ad 16, iv) information related to entering key words and selecting input 10 or the ad 16 based on results provided in response by ad suggestion interface module 12 or v) combinations thereof. Suitable interface components to enable an ad suggestion by person 4 can include but are not limited to one or more of a: drop down box, search box, a scroll down bar, tool bar buttons, menus, text boxes that accept user input, check boxes, images tiles that each show a separate product, and the like. In one embodiment, the interface components can be formulated as a GUI for output to an electronic device, such as 5a or 5b. These interface components can allow suggester 4 to suggest or specifically select one or more electronic advertisements, such as 16, from a set of advertisements available on system 2. Further, the interface component components can allow an ad suggester to view their progress related to suggesting ads, such as whether suggested ads that they previously sent have resulted in a purchase and associated compensation.

The advertisement provision module 14, or ad provision module 14 can refer to any device, system or tool within system 2 configured to send ad 16 to intended recipient 8. Ad provision module 14 is communicatively connected to ad suggestion interface module 12 and can be configured to receive data representing or at least partially identifying ad 16 from ad suggestion interface module 12. Ad provision module 14 sends data that allows intended recipient 8 to view the advertisement 16 suggested by the suggester 4 in an electronic format. In general, ad provision module 14 sends any suitable data for displaying, representing, identifying, rendering or outputting an ad 16 on a device 8. In a specific embodiment, ad provision module 14 sends a jpeg image or other suitable graphics format for the ad 16 when the ad includes graphics data for display on an electronic device, such as 5b. In another specific embodiment, the ad provision module can send audio files that allow an audio description of the ad to be output. Another specific embodiment suitable for use herein sends a hyperlink to the device 5b, which when displayed, calls for the ad 16 to be rendered in a browser.

In one embodiment, the electronic advertisement suggester selects a specific ad via the interface generated by ad suggestion interface module 12, and ad provision module 14 relays this ad to the recipient 8. In another embodiment, suggester 4 only suggests a general advertisement or topic related to the ad 16 that is eventually sent to the recipient 8. In this case, the suggester does not provide input that identifies a specific ad, but provides non-specific criteria that relates to a set of advertisements that fit the non-specific criteria. The advertisement input 10 in this case includes insufficient detail to identify an ad that will be sent. Instead, the non-specific input results in a set of advertisements that fit the non-specific criteria. This leaves ad provision module 14 to select a specific advertisement 16 that will be sent to the recipient. In this instance, the consumer information 10 provided by the ad suggester 4 allows the system 2 to act as an ad suggester.

It should also be appreciated that an ad selected by suggester 4 may not be the same advertisement 16 received by recipient 8. For instance if the ad or produce contained therein has expired since it was created, the system can select a similar or related ad to send to the recipient 8. In one embodiment, if a suggested ad, such as 16, a specific deal and deal expires before the ad is converted, the system 2 can be configured to notify the ad suggester 4 that the suggested ad is no longer valid and/or notify the ad suggested of a related ad that is valid and can be selected.

An electronic advertisement 16 that is sent via system 2 can convey any commercial opportunity to recipient 8 or other message for a potential consumer transaction. Electronic advertisement 16 can include any format or data suitable for conveying the commercial opportunity to an ad recipient. The advertisement 16 can include one or more of video data, audio data, text, graphics information, or any combination thereof. Electronic formats suitable for conveying and delivering ad 16 include: an email, an instant message, a text message (SMS or MMS), in situ ad in a web browser, a weblog (blog), a social network environment, a news feed, a webpage, a status post, a twitter update, graphics for display on a display device, an ad overlay, a banner ad, an in-situ ad in a video feed, etc.

In one embodiment, the system 2 can be configured to allow the ad suggester 4 to personalize a suggested ad, such as 16. For instance, in the father son jewelry example, the ad may show a picture of the son, or the son can append a note to the ad for the father saying, “I overheard mom talking about this item at the jewelry store.” This note can be displayed with the suggested ad 16 sent to the father. The son's picture allows the father to confirm the relationship with the sender (son), while the note additionally provides consumer information 6 that can aid the father 8 in the purchase. The son's picture and addition of the consumer information 6 may increase the likelihood that purchase associated with the ad 16 occurs.

Recipient 8 may view an ad 16 in a wide variety of digital communication environments. In one embodiment, a social network environment displays the ad 16. In another embodiment, ad 16 is displayed in an online chat, instant message, mobile application, text message, or email. Ad 16 may also be displayed in the space of the recipient's internet browser dedicated to displaying ads. This may be done for any web page visited by the ad recipient. Other display schemes are contemplated and ad 16 is not limited to any specific display arrangement for ad 16.

Recipient 8 may then purchase the item in the ad 16 by clicking or selecting the ad 16. This activity may be tracked in order for system to be aware of the purchase, and to attribute compensation to the ad sender 4.

It is contemplated that some actions performed by intended recipient 8 may be performed while intended recipient 8 is not online For example, intended recipient 8 can receive advertisement 16 on a mobile device and subsequently travel to an offline location, e.g. a store, maintained by an advertiser, or an affiliate of the advertiser, such as a merchant, retailer, wholesaler, among others. Printed ads from a computer also permit an alternative to recipient 8 from needing to bring his electronic device to a brick and mortar participating store. The printed ad can include identifying information that allows the ad to be identified as a suggested ad from system 2. The recipient 8 may also use a mobile device to initiate and/or complete a transaction in an online marketplace or in a brick and mortar participating store. Such mobile commerce techniques are known to those of skill in the art. In one example, the recipient's mobile device digitally contains payment information, such as a credit card number. Participating storefronts or merchants permit the recipient to use the mobile device as a method of payment, such as using near field communication technology.

### Compensation in an Interpersonal Electronic Advertising System

System 2 can be configured to track what recipient 8 does in response to receiving ad 16. The tracked information can be used to attribute compensation to suggester 4. The tracking can include but is not limited to determining whether the recipient has acknowledged receipt of the ad, whether the recipient has visited a physical or virtual location associated with the ad, and whether a purchase has resulted in response to receiving the ad 16.

In embodiment, to determine whether an ad has resulted in a purchase, during a transaction for a product or service, recipient 8 may present an ad 16 where the ad 16 includes a bar code or other identifier for the ad 16 that represents advertisement redemption data that was originally supplied by the store. Further, the ad 16 can include information that links it to system 2. During a transaction where ad 16 is utilized, the recipient's device, such as 5b, and/or a device controlled by a merchant associated with an ad may then send a message to system 2 indicating that a transaction occurred. The ad includes a unique identifier that identifies the ad 16 (and its specific ad sender and recipient and product) and the system 2 can be configured to store this result to storage 30 as a successful ad suggestion for suggester 4. As is described more detail below, information related to successful suggestions can be used to rank ads that are displayed via system 2. The compensation module 32 can receive information regarding the successful ad suggestion and use it to attribute compensation to the ad suggester 4.

In one embodiment, the store, advertiser, affiliate, or intended recipient 8 can take action to provide information to the system 2 that verifies that a particular transaction occurred in response to electronic advertisement input 10. For example, the advertiser, affiliate or intended recipient 8 accesses a network, and tracking software associated with the ad 16 transmits notification of a successful consumer transaction made by recipient 8 relating to the ad 16 or digital coupon 16 suggested by suggester 4. In other embodiments, system 2 implements automated notification of a transaction by recipient 8 using software stored on merchant web software that is specifically triggered based on ad 16. So long as system 2 receives affirmation of a consumer transaction relating to ad 16, then system 2 knows that the transaction occurred and may attribute a compensation to ad suggester 4 or another financial destination designated by suggester 4 (such as a bank account for a charity designated by suggester 4).

The compensation module 32 can be configured to attribute an incentive or compensation within interpersonal advertising system 2. Compensation can refer to any type of incentive, whether monetary, or in another form such as a discount on a present or future consumer transaction, coupon, merchandise, award, products, services, electronic tokens, virtual currency, rebate, among others.

Compensation module 32 can attribute compensation to a compensation destination designated by suggester 4. Module 32 can attribute compensation directly to ad suggester 4, such that the compensation is accessible to the ad suggester. In another embodiment, compensation can be attributed to an alternative destination specified by suggester 4, such as a charity. In this instance, the compensation may not be accessible to the suggester 4 once it has been attributed. However, the system 2 can be configured to maintain records accessible to the suggester 4 that indicate a number and an amount of compensation that has been attributed to entities other than the ad suggester 4.

To allow compensation, the system 2 can be configured to receive information, such as electronic payment information, that allows compensation to be transferred to an account specified by the ad suggester. For example, to enable personal compensation, an ad suggester 4 may provide a personal checking account number to system 2 via an interface generated or supported by the system 2, such as an interface supported by the ad suggestion interface module 12. The compensation enabling information can be stored to storage 30.

When it is time to attribute compensation to the ad suggester, the compensation module 32 can retrieve the previously specified payment information. For example, when payment information includes checking information, the compensation module 32 can subsequently deposit funds in the specified checking account using the retrieved payment information. In general, the payment information can be related to: a bank account, a PayPal™ account, Spare Change account, among others. Bank accounts may include personal accounts, business accounts, those for charitable organizations, etc. Digital credits and tokens are also suitable for use.

As noted above, compensation as contemplated herein is not limited to direct compensation of the ad suggester 4. For example, a grandparent may designate attributed compensation to the bank account for a grandchild. A suggester that supports a charity may designate the charity, or a specific bank account for a charity if known, as a financial destination for one or more ad revenues. Multiple people may also specify the same charity, thereby cumulatively generating significant funds for the charity only using actions by its supporters. Thus, the payment information input into system 2 can be associated with a financial destination that is not accessible to the ad suggester 4.

In particular embodiments, the system 2 can be configured to allow an ad suggester 4 to attribute compensation to a financial destination on ad by ad basis. For instance, the ad suggester 4 can designate that if a first suggested ad results in compensation the proceeds will be credited to the ad suggester and that if a second suggested ad results in compensation the proceeds will be credited to a third party, such as a charity. The system 2 can be configured to allow a user to view for each suggested ad the designated recipient of compensation that may result from ad and allow the user to change a previously specified designated recipient of a suggested ad.

Compensation module 32 can receive a notification that recipient 8 activated electronic advertisement 16. A component of system 2, such as module 32, may place or embed a tracking identifier and/or tracking program for an advertisement, such as 16. The identifier or tracking program can include a unique identifier or software used to track the status of the ad, such as an alphanumeric code, a hexadecimal string, a cookie, etc. Whenever recipient 8 activates the ad, that activation can be tracked by module 32. If a product or service is purchased, then recipient 8 pays the advertiser, vendor or seller, or an intermediary for either, and the advertiser, vendor or seller compensates electronic advertising provider 28 for that activation. In one embodiment, compensation module 32 uses cookies to track ad and purchase status or other recipient 8 activity in response to an ad 16.

FIG. 2 illustrates a method 101 for attributing an incentive or compensation within an interpersonal advertising system in accordance with a specific embodiment of the present invention. Method 101 begins by receiving a designation of a compensation destination (103) for compensation resulting from providing input for a suggested advertisement. Compensation may be attributed to any bank account or other suitable electronic compensation destination. For example, an ad suggester may provide a personal checking account number to the interpersonal ad service at 103. The payment information associated with the compensation destination can be used to subsequently send funds to the location specified by the payment information.

Next, in 89, an ad can be selected by an ad suggester and the selected ad can be sent to an ad recipient. Next, in 107, a notification that the ad recipient activated an electronic advertisement can be received. Activation of an electronic advertisement may include one or more of: 1) completing a transaction that was initiated using the suggested ad (e.g., the recipient was sent to a website to make the purchase using a link embedded in the ad 16), 2) completing a transaction that otherwise corresponds to suggested ad (e.g., the ad brought the ad recipient to a retailer's website, and the recipient purchased a product or service similar to the product or service conveyed in the electronic ad but not the particular product or service conveyed in the electronic ad), 3) acknowledging the suggested ad (e.g., opening an e-mail or text including the suggested ad), 4) visiting a physical or virtual location associated with the suggested ad or combinations thereof.

In one embodiment, the system can attempt to proactively or periodically verify whether the intended ad recipient has activated a suggested advertisement. If the recipient activated the electronic advertisement, then method proceeds to 111. If the intended recipient hasn't activated a suggested ad, after some time period, a check can be made again to determine whether a suggested ad has been activated. The system can continue make these checks until the verification returns an affirmative result or until the suggested ad is terminated.

As described above, a tracking number and/or tracking program can be embedded in a suggested ad. The tracking numbers can refers to one or more unique identifiers used to track the status of the suggested ad. When a suggested ad is in an electronic format, a tracking program can be embedded in the suggested ad. When the suggested ad is activated, the tracking program can be configured to report a unique identifier back to the interpersonal electronic advertising system.

Thus, whenever a recipient activates the ad, that activation can be tracked online and signaled to the interpersonal electronic advertising system. If a product or service is purchased and the recipient pays the advertiser, vendor, or seller, or an intermediary, the advertiser, vendor or seller can compensate the interpersonal electronic advertising system. Next, the proceeds can be divided between the ad suggester, an operator of the interpersonal electronic advertising system and possibly a third-party partner associated with the operator.

In one embodiment, electronic tokens, such as cookies, can help track suggested ads, a purchase status associated with ad and/or other recipient activity resulting from receiving the suggested ad. In a specific embodiment related to online use, cookies can be used in two stages of online recipient tracking: 1) at the load of the suggested ad and 2) when the suggested ad is clicked and the recipient that initiated the click is delivered to the seller or a website for the seller, such as Amazon™, to make a purchase. Thus, the use of cookies can enable compensation for an ad suggester when the recipient activates a suggested ad. This compensation can be separate from the compensation that results if a purchase is actually made.

Next, in 111, compensation can be attributed to the operator of the interpersonal electronic advertisement system 2 described above in FIG. 1. In one embodiment, only the operator of the system and the ad suggester share the proceeds resulting from a successful purchase. The proceeds can be paid by a vendor that benefited from the purchase enabled by the ad suggester and the suggested ad provided by the interpersonal electronic advertising system. In a specific embodiment, the ad suggester and the system operator split the proceeds 50/50. In another specific embodiment, the ad suggester and system operator split the proceeds 30/70. Other splits are possible and are not limited to these examples.

In other embodiments, more than two parties can split the proceeds resulting from a successful ad suggestion. For instance, a social network site can host an ad suggestion interface. The ad suggestion interface can be coupled to the interpersonal electronic advertisement system. Proceeds associated with the activation of the suggested ads generated from the hosted interface can be split among the ad suggester, the operator of the social network site and the operator of the interpersonal electronic advertising system. In another specific embodiment, the electronic ad service provider receives compensation for providing the advertisement to the intended recipient, without any further activity by the recipient. If the ad was sent to the recipient via a social network, process flow can attribute at least a portion of the compensation to the social network. If a purchase subsequently results from the ad, then additional compensation can be attributed to one or more entities that participated in the process leading to the purchase.

Next, in 115, compensation can be directed to the financial destination associated for the suggested ad. The financial destination may have been designated in 103. In one embodiment, in 115, a record of the suggester's electronic advertisement input and the suggested ad that corresponds to the input which was sent to the intended ad recipient can be stored. Further, the system can store a record indicating that the compensation has been attributed including information regarding a compensation destination for the funds.

Compensation for a purchase may vary. In one embodiment, process flow 101 attributes compensation to an ad suggester based on a percentage of a transaction, where the percentage does not change over time. A compensation percentage that does not change between successive activated ads is referred to herein as a ‘flat rate’ compensation percentage. In the jewelry store example described above, the son may receive a flat rate compensation percentage for all of his suggested ads, such as 5%, therefore receiving 5% of the transaction price of his father's purchase at jewelry store.

In another embodiment, a variable compensation structure can be implemented. For example, an ad suggester can be paid a higher compensation percentage on their first ad that is successfully acknowledged by an ad recipient, or their first ad that successfully resulted in a purchase by the ad recipient. The higher initial compensation might be used as incentives in order to enlist new ad suggesters to utilize the system. After the first ad is acknowledged and/or results in a subsequent purchase, a second compensation percentage (e.g., a lower flat rate) can be implemented for the ad suggester.

In another specific embodiment, the ad suggester can receive a compensation percentage until a minimum number of ads are sent, so as to provide initial incentive to utilize the interpersonal advertising system. After the minimum numbers of suggested ads are sent, the incentive structure can change, e.g., it can go o a flat rate or becomes variable according to the tiered system. In this second instance, once the minimum numbers of ads are sent, the system can be configured to change the incentive in relation to the number of successful activations. In this manner, an ad suggester receives a first compensation percentage for an initial threshold number of ad suggestions, and receives a variable rate of return, as further described above, once the initial threshold is met.

In some embodiments, the dynamic rate of return does not fall below the initial flat rate. For example, a sample incentive scheme offers compensation for the first twenty suggested ad activations at 5% of the corresponding transactions. The ad suggesters first suggested ad can be a jewelry store ad to his father. The father can activate the ad by using it at jewelry store in a consumer transaction. The total purchase price can be $500, the ad suggester (son) son receives $25 since it was son's first suggested ad. The son can continue to receive this 5% rate for activations of his suggested ads until he provides twenty (or some other threshold) suggested ads that result in ad activations. Subsequently, another transaction scheme, such as a variable compensation scheme can be utilized.

Other compensation schemes are contemplated. Commissions may vary between merchants. In another embodiment, the compensation percentage varies in relation to the total amount of the transaction price. For example, the incentive rate for a $100 ski rack might be 5%. Thus, the ad suggester of the ski rack receives $5 dollars when a purchase results from the suggested. Whereas, the incentive rate for a $10,000,000 home purchase or yacht might be 1% and the ad suggester receives $100,000 dollars. In this manner, a business can control how much it rewards suggesters to bring customers to the business. In another compensation scheme, a flat fee for a purchase can be implemented that is irrespective of the purchase price or conversion rate or any other factor. For example, an ad suggester $3 can be paid for a certain ad that converts into a purchase by the recipient. After attribution of compensation in 115, the 101 may repeat and return to 89 and new electronic advertisements can be sent to the recipient.

### Ad Suggestion Effectiveness Metrics

In the embodiments, described herein different metrics can be generated to characterize an ad suggester's effectiveness at suggesting ads to ad recipients. The ad suggester's determined effectiveness can vary from person to person. For instance, an ad suggester may be very effective at suggesting ads for their parents but not so effective at suggesting ads for their younger sibling. As another example, an ad suggester may be very effective at suggesting ads for their spouse but not so effective at suggesting ads for their adult children.

Besides from person to person, an ad suggester's effectiveness can be defined in many different ways. For instance, a metric of an ad suggester's effectiveness can be determined within different price ranges, such as effectiveness at suggesting ads for products between $1000 and $500 dollars as compared to ads for between $100 and $50 dollars. As another example, a metric of an ad suggester's effectiveness over time can be determined. In yet another example, a metric of an ad suggester's effectiveness within product categories can be determined, such as travel products or furniture. Further, a metric of an ad suggester's effectiveness can be determined for ad suggested for a particular product. These metrics are provided for the purposes of illustration only and are not meant to be limiting.

The metrics listed above can be determined on a per person basis or on a group basis. For instance, an ad suggester's effectiveness at suggesting ads for products or services between $500 and $100 dollars can be determined for ads sent to a particular ad recipient over time. In another example, an ad suggester's effectiveness at suggesting ads for products and between $500 and $100 can be determined for suggested ads sent to a group of recipients over time. In yet another example, an ad suggester's effectiveness can be determine for suggested ads sent to recipients in particular age ranges, such as over 50 years of age or between 20 and 55 years of age. The metrics listed above can also be determined for different time periods, such as the last week, last month, last 6 months, last year, etc.

One metric for measuring an ad suggester's effectiveness at selecting suggested ads for ad recipients can be referred to as a conversion rate. In one embodiment, a first type of conversion rate can correspond to a total number of ads resulting in purchases relative to a number of suggested ads sent.

In another embodiment, a second type of conversion rate can correspond to a total number of ad activations including activations resulting in purchases and activations resulting in non-purchases (e.g., the ad is selected, the ad recipient goes to a site displaying products associated with the advertisement and views additional advertising. However, the ad recipient doesn't purchase a product or service associated with the suggested advertisement.)

The conversion rate may be determined using a number of techniques and with a variety of inputs. For example, one suitable conversion rate can use a ratio of a number of prior suggested ad activations (purchase only) for a suggester related to the number of prior of suggested ads sent by the ad suggested over some time period. The conversion rate may be determined using statistics between: a) an ad suggester and ad recipient, b) an ad suggester and all his ad recipients, c) an ad suggester and a group of contacts (e.g., ski trip friends, or college friends, etc.), d) an ad suggester and his family, e) an ad suggester and his four or five most frequent ad recipients, and/or f) combinations thereof. In a specific embodiment, the conversion rate is a global conversion rate for all the suggested ads sent by a suggester and is determined at the time of sending an advertisement to the recipient. It is noted these types of determinations can also be utilized for other metrics associated determining an effectiveness of an ad suggester and is not limited to the conversion rate.

Effectiveness metrics, such as conversion rates, can be used in the systems and method described herein for different applications. In one embodiment, effectiveness metrics can be employed in the compensation methods described above with respect to FIGS. 1 and 2. A variable rate of compensation tied to an effectiveness metric, such as a conversion rate, can be used within the interpersonal electronic advertising system to incentivize ad suggesters to provide electronic advertisement input and ads that are highly likely to result in purchases by recipients. It can also be used to disincentive spamming where a user tries to send a large number of suggested ads with a low probability of succeeding. Examples of utilizing a conversion rate in a compensation scheme are described with respect to the following paragraphs. When used in the method 101 described above with respect to FIG. 2, the conversion rate can be periodically updated so that a compensation percentage can reflect changes to the conversion rate.

In the jewelry store example, the conversion rate can be used to determine the son's compensation on his father's purchase. As described above, the conversion rate can be calculated in many different manners, such as on a per ad recipient basis or globally for all of the son's ad recipients. For example, if the son in the jewelry example previously sent forty suggested ads and twenty were activated for purchases, then his conversion rate would be 50% suggested ads leading to purchases. If all forty of his ad suggestions were activated for purchases, the son's conversion rate would be 100%. As the son's conversion rate increases, the system can be configured to increase his compensation for a given activation Likewise, as his conversion rate decreases, the system can be configured to lower his compensation. In this manner, son is incentivized to select suggested advertisements that are more likely to result in recipient activation. In one embodiment, if an ad suggester's rate becomes very low over some time period, i.e., the suggester is an ad spammer, the system can be configured to block the suggester from sending additional suggested ads.

In accordance with the example in the previous paragraph, the system can be configured to use a tiered conversion rate scheme to attribute compensation to an ad suggester. The tiered scheme can includes a number of tiers for the ad suggester's conversion rate, where each conversion rate tier conveys a dedicated compensation rate. Changes (up or down) to the ad suggester's conversion rate can cause their compensation to move between the conversion rate tiers and their predetermined conversion rate thresholds resulting in different compensation rates. Typically, a higher conversion rate tier results in a higher compensation percentage using the tiered system. For an increasing conversion rate, once the next conversion rate threshold number is reached, the system can be configured to increase the compensation.

As described above, the conversion rate can vary over time. In one embodiment, a compensation of the transaction can be based on the ad suggester's conversion rate at the time of sending the ad. In another embodiment, the compensation of the transaction can be based on an average of the ad suggester's conversion rate at the time of sending the ad and the ad suggester's conversion rate at the time the ad is activated. In general, a conversion rate used to attribute compensation can be based upon conversion rates calculated at one or more times when compensation is being attributed for a particular suggested ad.

In a particular example, the conversion rate used to attribute compensation can be determined at the time an ad is suggested. In the jewelry example, if the son's conversion rate is 19%, and he suggests a jewelry store ad to father, and father activates the jewelry ad, the ad activation, depending on how the conversion is calculated, can elevate the son's conversion rate above 20%. When the conversion rate tiers are set at 10% increments, such as 10%, 20%, 30%, 40%, etc, the new higher conversion rate indicates the son may possibly earn additional compensation. In this embodiment, however, the system is configured to determine conversion rate at the time the ad is suggested for the purposes of attributed compensation. Thus, since the son suggested the ad while his conversion rate was 19%, the system is configured to receive compensation based on the compensation structure for a 19% conversion rate. On future activated ads, however, the son is eligible for the higher compensation at the compensation rate given to the high tier at 20%, while his conversion rate remains above 20%.

A tiered conversion rate compensation scheme may employ any number of tiers, where each successively higher tier conveys an increased compensation, and each tier having a minimum conversion rate or other metrics such as total revenue for the ad sender to qualify for the increased compensation percentage. When the conversion rate decreases to below the threshold level for a tier, the suggester's compensation percentage decreases to correspond with the lower conversion rate tier.

In one embodiment, the system can be configured to allow a user to select a tiered compensation system. For instance, a first compensation tier scheme can include larger compensations for higher ad conversion rates and lower compensations rates for lower ad conversion rates in particular tiers as compared to a second compensation tier scheme. The user may select the first compensation tier scheme because they believe they can maintain a high conversion rate. Thus, the user is willing to take the risk of using the first compensation tier system which may result in lower compensation if the conversion rate is not maintained but higher compensation if the conversion rate is maintained. A second user may be more conservative and choose the second compensation tier. The second user will earn more compensation at a lower conversion rates but less compensation if they obtain and maintain a high conversion rate.

In various embodiments, the compensation tiers can be used to attribute compensation to an ad suggester when an ad recipient makes a purchase that has been linked to the suggested ad. In addition, the compensation tiers can be used to attribute compensation to an ad suggester even if the ad recipient doesn't make a purchase. For instance, in some embodiments, compensation can be attributed to the ad suggesters for ad activations where the ad recipient has acknowledged receipt and/or awareness the ad in some manner.

As described above, an ad can be output via an interface that is configured to receive an input that indicates the ad has been acknowledged. For instance, via a GUI, an ad recipient can provide an input via an input device, such as a touch screen, a mouse or a track pad, that indicates a selection of the ad by the ad recipient. As another example, via an oral interface such as a digital assistant like Siri by Apple™, the ad recipient can request, verbally, information about the suggested ad. In response, the digital assistant can output a verbal description of the suggested advertisement. The input received from an interface from which a suggested ad is output can be used by the system to determine the ad recipient has acknowledged the ad in some manner. In response to the acknowledgement of the suggested ad, the system can attribute compensation to the ad suggester. Further details of interfaces that can be used to output ads are described below in the following section.

### Interfaces for Outputting Suggested Ads

As described above, various types of interfaces can be used to output suggested ads derived from an interpersonal electronic advertising system. Many types of interfaces can be primarily graphical in nature. However, other types interfaces, such as interfaces that are primarily sound based, like an interface based upon verbal commands and verbal responses using a digital assistant like Siri from Apple™ can also be utilized. Various input and output devices can be used to allow a user to interact with the interfaces. Examples of input devices that can be utilized include but are not limited to 1) touch sensitive devices, 2) sound detection devices that can include speech processing capabilities, 3) motion detection devices, such as devices incorporating cameras or accelerometers to detect motion to indicate inputs, and 4) mechanical devices such a keyboard or a mouse. Examples of output devices used with an interface can include but are not limited to video displays, sound generation devices that can include speech synthesis capabilities and haptic devices that generate detectable vibrations.

FIG. 3 illustrates a graphical user interface 201 for displaying a viewable page including one or more suggested ads, such as a page output via a web-browser. The interface 201 has content 45 that is displayed to the page, and is configured to allow ad suggesters to contribute one or more of ads 16a, 16b and 16c. As shown, the page displayed by the interface includes locations for the placement of up to three advertisements where one or more of the placed ads can be suggested ads. Other pages formats are possible and the example is provided for the purposes of illustration only. The content 45 displayed on the page can vary depending on the purpose or theme of the page.

In one embodiment, the viewable page can be owned by a particular individual. Ownership may allow the individual to change aspects of what is displayed on the page at a particular time. In some instance, the interface 201 can be configured to generate a viewable page with one or more of a contacts module 175, an ad suggestion interface link 205 a dashboard link 207. The contacts module 175 can include a list of individuals associated with the owner of the page. As described below, the interface 201 can be configured to allow a user to suggest ads for individuals or groups of individuals. In some instances, contact information for the individuals or groups of individuals can be retained in the contacts module 175.

A selection of the ad suggestion interface link 205 can cause interface 201 to generate a page that allows a user access a database of ads that can be selected for particular ad recipients, such as individuals stored in the contact module 174. A selection of the dashboard link 207 can cause the interface 201 to generate a dashboard page that allows the user to assess a status related to the suggested ads they have previously suggested. For instance, via the dashboard page, a user can view information such as but not limited to a list of suggested ads they have previously sent, whether suggested ads have been activated and by who, ad suggestion effectiveness metrics, such as conversion rates related to the activation of suggested ads, past attributed compensation, etc.

In one embodiment, an interface for displaying suggested ads can be compatible with social media applications. When the interface 201 is used a social media environment, a portion of the content 45 that is displayed can be social media related. In other contexts, the content 45 displayed in the interface can be different. For example, if the interface 201 is used to access a web-site, the content 45 that is displayed can be consistent with a theme of the web-site.

In a specific embodiment, the interface 201 can output a social network profile page associated with a particular individual. In this case, the social network content 45 can include content personal to the individual. As an example, the content 45 can include news feeds, a status post, a news update, etc of interest to the individual.

In one embodiment, the interpersonal electronic advertising system can be configured to allow an individual to suggest ads for visitors to their social network profile page that are displayed via interface 201. In this example, ads 16a, 16b and 16c can be suggested ads selected by the owner of the page. When other individuals with a relationship to the individual visit the page, the interface 201 allow the visitors to activate the displayed suggested ads, such as 16a, 16b or 16c. After the suggested ads are activated, the owner of the social network profile page (ad suggester) can be compensated. The compensation rewards the page owner's efforts related to suggesting ads, gathering consumer information and social networking activities.

In one embodiment, when a social profile page is visited, the same suggested ads are displayed to everyone. In other embodiments, the system is configured to customize the suggested ads to each visitor. Thus, the ad suggester can suggest ads that are for an individual ad recipient or a group of ad recipients that visit their page. When an individual visits the page, the system can be configured to identify the visitor and then determine whether there are any suggested ads for the individual from the owner of the page. In one embodiment, when the owner of a page visits their own page, the system can be configured to display ads suggested for them from other individuals and/or ads they can select for others.

In the jewelry example described above, the son can create a social profile page via interface 201. Then, using the ad creation tools described herein, the son can provide input to create a suggested ad for his father, such as the jewelry advertisement. The suggested ad can be delivered to the father via some communication mechanism, such as text or e-mail. In addition, when the father 8 visits his son's page, the system can be configured to identify the father and determine whether there are suggested ads just for the father or the father falls within any groups that have been designated to receive a particular suggested advertisement. As an example, the son's 4 suggested advertisements for his father can include a jewelry store suggested ad 16a, a new family computer suggested ad 16b, and a sports car suggested ad 16c. Thus, father 8 visits his sons social profile page and the father can view a number of suggested ads from his son, such as 16a, 16b and 16c. As noted above, the interpersonal ad system 2 itself can also suggest ads for the father based on some partial input from the son or another person who knows commercial information regarding the father and has provided input to the system 2.

In some embodiments, the number of suggested ads for the father can be greater than the number of ad locations available on the page. For example, a son may have selected ten suggested ads for their father. However, only three locations are available for displaying the ads. In this situation, the system can be configured to rank each of the suggested ads relative to one another and display the top three ads.

When someone else visits the son's social profile page, a different set of ads can be displayed. For example, when his mother visits his page, a suggested ad for books the mother wants can be displayed in ad 16a, a suggested ad for a new family computer displayed can displayed in ad 16b, and a suggested ad for a spa getaway package in ad 16c. In the example, the suggested ad for the new family computer is displayed to both the mother and the father. The son may have selected that the ad for the computer to be displayed to family members. Further, the son may have identified the mother and the father as family members to the system. When the mother or father logs onto the system, the system can determine that the father or the mother are family members and then determine the new family computer suggested ad is to be displayed to each of them.

In general, the system can be configured to allow an ad suggester to define groups and then suggest ads for the group. For instance, the system can be configured to allow the ad suggester to create a group and then populate it from their contacts using the contacts module 205. The system can be configured to allow the user to delete or modify the members in a particular group. In particular embodiments, the system can be configured to allow an ad suggester to select the same suggested ad for multiple different groups.

As an example, an owner of the page can select the ad suggestion interface link 205 and the interface 201 can display an ad suggestion interface page. Via the interface, an ad can be selected for a discount ski pass for a particular resort 16. Next, the interface 201 can be used to create and populate a group, such as “ski friends.” Then, the ski pass suggested ad can be selected for the group “ski friends.” When someone in the ski friends groups views the social network profile page via interface 201, the system can identify the person as being a member of the ski friends group and the suggested ad for the particular ski resort can displayed. The ad suggester can be compensated at least each time one of the friends in the group purchases a lift ticket via the advertisement.

The interface 201 is not limited to displaying only three ads. In general, the interface can be configured to output one or more ads. The number of ads that are displayed to a page can vary over time. In addition, the system can be configured to vary the size and the placement location of the one or more ads displayed to a page at a given time. Further, the system can be configured to vary the content and format of a displayed advertisement. For instance, at one time, the content and format of a first suggested ad for a product can include selected content formatted to be output as a video with sound. In another embodiment, a second suggested ad for the same product can include selected to be output as a still image without sound.

Multiple suggested ads can be provided for the same product and the system can be configured to select from among the multiple ads to output via the interface. For example, at a first time, a first suggested ad 16a can be output for a particular product. Then, at a later time, the system can refresh the social media profile page and a second suggested ad for the same product can be displayed, e.g., from a different person who also knows of a looming transaction for the ad recipient.

A particular number of ad spaces in which suggested ads are output can be specified for a particular page format. For example, in FIG. 3, the page is configured with 3 ad spaces. In some embodiments, the number of suggested ads for available for a particular page format can be less than or greater the number of ad spaces that are available for suggested ads. When the number of suggested ads is less than the number of ad spaces, in one embodiment, the system can be configured to suggest ads to fill the unallocated ad spaces. In another embodiment, the system can be configured to only display the one or more available suggested ads. For example, if only one suggested ad is available, then for the page in FIG. 3, only one suggested ad might be displayed in location 16a and the locations for 16b or 16c can be left blank or the only suggested ad can be displayed in all three locations. In yet another embodiment, the system can be configured to reformat the page to reduce or eliminate the unfilled ad spaces. For instance, if one suggested ad is available, then the interface can be configured to expand the size and/or rearrange the remaining components, i.e., ad 16a, content 45, contacts module 175, ad suggestion interface link 205 and dashboard link 207 such that at least a portion of the available space associated with 16b and 16c is filled by the other page components. The empty ad spaces may also be filled with ads send by the father, to remind him of interpersonal ads 16 that he has sent.

When the system determines that more suggested ads are available then ad spaces are available on page, in one embodiment, the system can be configured to adjust the format of the page to increase the available ad spaces. For instance, if four suggested ads are available for the page shown in FIG. 3, the system can be configured to adjust the format of interface 201 to include 4 ad spaces instead of 3. The re-formatted can involve rearranging and resizing various components on the page.

In another embodiment, when more suggested interpersonal ads are available for a page then open ad spaces available on interface 201, then the system can be configured to rank the ads. Based upon the rankings, the system can distribute the ads to the ad spaces available on a page provided by interface 201. For example, if the system determines ten suggested ads are available for the page shown in FIG. 3, then the system can be configured to rank in order each of the ten ads and then display the three ranking highest ads to ad spaces 16a, 16b and 16c.

### Ad Creation Interface Components and Layout

In this section, one or more interfaces that allow a user to create interpersonal ads and monitor their ad activities within the interpersonal electronic advertising system are described. Details of an ad creation interface are described below with respect to FIGS. 6-20. The ad tracking interface can be referred to as an “ad dashboard” interface. Interpersonal ad monitoring can include tracking the status of suggested ads that a person has generated via an ad creation interface.

FIG. 4 illustrates components of a dashboard interface configured to allow a user to monitor their activities within the system. A layout 200 showing one embodiment of an arrangement of the dashboard interface components is described as follows. The top right corner of the layout 200 can include a logo 202. In the example, a logo for TrustedAd™ is shown. The logo 202 can be associated with an operator of the system. At the top center of the page, a selectable link 204, “Send and Ad,” is shown. A selection of the link 204 can cause the system to generate a suggested ad creation interface (see FIGS. 6-20). The suggested ad creation interface can allow a user to create and send a suggested ad to an ad recipient.

A welcome “user” message 204 is displayed in the top right corner of the layout 200. The welcome user message can include a portion of the user's name, such as the first name “Will.” The user's name can be associated with an account holder that has logged into the system where the dashboard interface includes information that reflects the logged-in user's activities on the system.

The “faq” 210 can be a selectable link (frequently asked questions). A selection of the FAQ link 210 can cause the system to generate one or more interface screens that include frequently asked questions and answers to the questions. Some examples of questions that can be included in a faq include but are not limited to a) “How many ads can I send?,” b) “When do I get paid,” c) “What happens if the ad recipient returns a purchase?”, d) “Have a question about a commission?”, e) “Can I change a financial destination before the commission pays?”, f) “Can I change a financial destination for a commission after the commission pays?” g) “Do commissions given to a charity count against me for tax reasons?”, and h) “Can I send ads to myself?”. Some example answers to these questions are described as follows.

In particular embodiments, the answer to “How many ads can I send?” can be “As long as your conversion rate remains above X % (e.g., 5%), the number of ads you can send is unlimited. Your account starts in a Y day trial period (e.g., 60 Days), during which you are limited to Z ads (e.g., 20 ads) until your suggested ads guide purchases. If you send Z ads without guiding a single purchase, then the system prevents you from sending new ads.” The answer to “When I get paid?” can be “The system does not get paid until the ad recipient's purchase clears the merchant's internal payment protocols. Each merchant pays at different rates. The merchant processing time is usually listed when an ad is selected for sending. When creating and sending an ad, the system encourages ad suggesters to select merchants that pay ad suggesters quicker.”

The answer to the question “What happens if the Ad recipient returns a purchase?”, can be “Each merchant has different terms that will affect returns. The ad terms may briefly explain these terms. Merchants and the system do not pay commissions for returned items. A returned ad shows up as a red processing arrow in the ad status window.” The answer to the question “Have a question a commission?” can be “Please email to commissions @company.com.” Additional or alternate contact means such as a phone number can also be provided as part of a question answer.

The answer to the question, “Can I change a financial destination for a commission before the commission pays,” can be “Yes. Just click on the financial destination for an ad in the ad status window. This needs to be done at least X days (e.g. 3 days) before the commission is scheduled for payment.” The answer to “Can I change a financial destination for a commission after the commission pays?” can be “No.” The answer to “Do commissions given to charity count against me for tax reasons?” can be “No. The commissions are paid directly from TrustedAd™ to the Charity that you have selected. You do not get to use these as a write off since the money was never actually paid to you.” Finally, the answer to the question “Can I send ads to myself?” can be “Yes. Some Merchants permit this so long as you are not purchasing using funds from a workplace. Some contribute the funds to charity for purchases they are already making”

In different embodiments, all or a portion of the questions listed above as well as additional questions can be included in a FAQ. Also, the answers to the questions can depend on a system configuration and can change depending on how the system is configured. For example, system can be configured such that the minimum conversion rate is 15%, the trial period is 30 days instead of 60 days and the cut-off at which the system stops are user from sending ads can be 15 ads instead of 20 without guiding a purchase. In this configuration, the answer to the question “How many ads can I send” can be “As long as your conversion rate remains above 15%, the number of ads you can send is unlimited. Your account starts in a 30 day trial period, during which you are limited to 15 ads until your ads guide purchases. If you send 15 ads without guiding a single purchase, then system prevents you from sending new ads.”

Returning to FIG. 4, a sign out link 208 is located in the top right corner of the layout 200. In one embodiment, a selection of the sign out link 208 can cause the system to log the user off and return the interface to a home or default screen associated with the system (e.g., see FIG. 6). At the home screen a link can be provided that allows a user re-login to the system, if desired, and again access the dashboard interface.

The recent ads component 214 can include a list of suggested ads. The list can be output in a text or graphical format. In one embodiment, the list can include suggested ads that the logged in user has sent to various ad recipients (the ad recipients may or may not be registered users of the system). In another embodiment, the list includes suggested ads for the user from other users of the system. The system may also toggle between interpersonal ads sent and ads received by the logged in user, or let the user switch between the two. In one embodiment, one or both of the lists of suggested ads that the user has sent or has received from other users can be displayed simultaneously in the layout 200. For example, the suggested ads that the user has sent to other individuals can be displayed on a right sight side of the layout and the suggested ads that the user has received from other users can be displayed on the left side of the layout 200 in a vertical arrangement. In another example, the suggested ads that the user has received can be displayed on a top of the layout 200 in a horizontal format, such as a horizontal strip above the profile 212 and the suggested ads that the user has sent can be displayed on a bottom of the layout 200, such as a horizontal strip below the ad status 232. In FIG. 4, only a single vertical strip 214 on the right side of the layout 200 is shown.

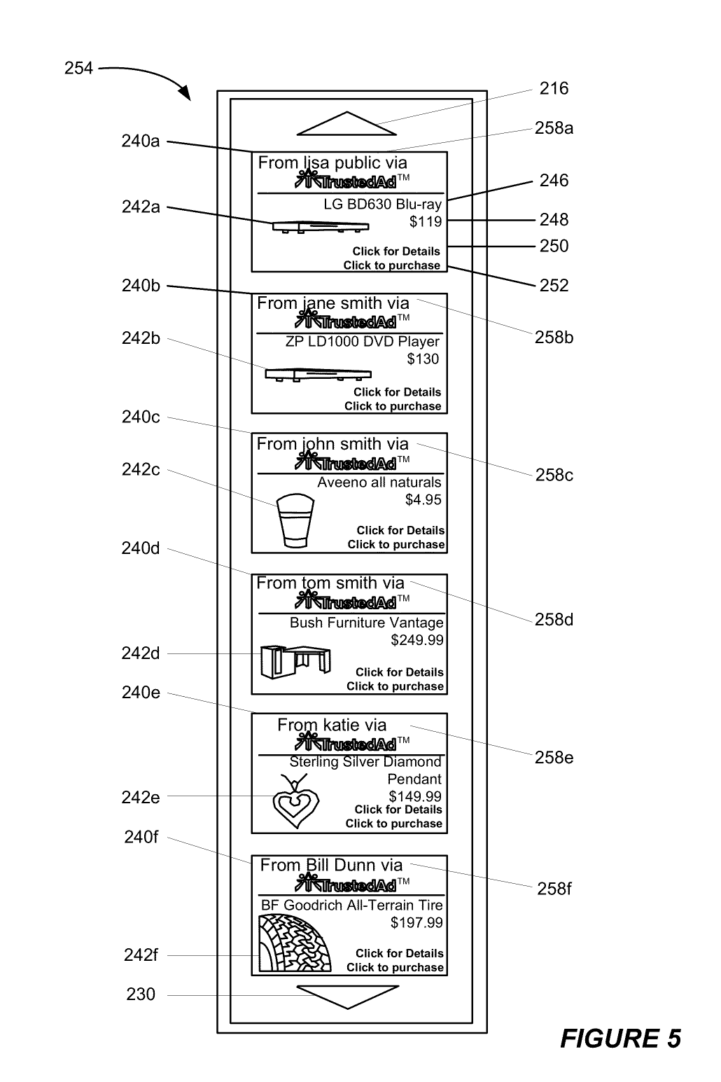

In one embodiment, a rank value for the suggested ads in a group can be determined. The rank value determines which ads are displayed when there are more interpersonal ads available than spaces to display the ads. The rank may apply a) separately to interpersonal ads sent, b) to interpersonal ads received, or c) a single ranking for both ads sent and received for the user. A list can be generated and ordered according to the rank value. Factors that can affect the rank value can include but are not limited to i) when the suggested ad was sent, ii) a commission associated with the suggested ad and iii) an ad suggestion effectiveness metric between the ad suggester and the ad recipient, such as a conversion rate. A more detailed example of a list of suggested ads received by the user including text and graphical elements is described below with respect to FIG. 5.

In FIG. 4, six suggested ads for a blu-ray player, a DVD player, lotion, a desk, a pendant and tire are displayed. A number of suggested ads on the list that can fit between the up arrow 216 and down arrow 230 in space 218 can be less than the number of suggested ads on the list. To view suggested ads that are not shown at a particular time, a user can select the up arrow 216 or down arrow 230. A selection of one of these arrows can cause the system to scroll through a generated list of suggested ads such that suggested ads that are not currently shown are shown and suggested ads that are currently shown are not shown. The order that the suggested ads on the list appear and disappear can depend on how the list is generated. For example, as described above in the previous paragraph, the list can be ordered according to a determined rank value. In another example, the list can be ordered chronologically according to when the suggested ads were sent.

The profile interface component 212 can include information about the user's profile on the system. For instance, the profile interface component 212 can include one or more of: an image of the user, an amount of commissions paid, an amount of commissions pending, a value of an ad suggestion effectiveness metric, such as a global ad suggestion effectiveness metric (such as a global conversion rate) or an ad suggestion effectiveness metric specifically between a user and one or more ad recipients to whom the user has sent ads, a message ticker displaying recent information, a commission rank, and a link that causes the system to display additional account information.

As examples, the amount of commission paid is $314 and the amount pending is $628.50. The ad suggestion effectiveness metric is a global conversion rate with a value of 17%. The commission rank is normal. The commission rank can indicate a rate at which the user is reimbursed for guided purchases. In some embodiments, users can be compensated at varying rates depending on a measure of their performance on the system, such as their performance as indicated by an ad suggestion effectiveness metric.

The account activity interface component 220 can include various details about a user's activities on the system from different perspectives. For instance, sections 222 and 224 can include values of parameters that characterize a user's activities within the system. The information in sections 222 and 224 can allow a user to evaluate their performance in the system. For example, section 222 can include more detailed information about suggested ads that the user has sent and suggested ads that have resulted in purchases (Guided purchases). A guided purchase can refer to a purchase where a suggested ad, sent from an ad suggester to an ad recipient, results in a purchase by the ad recipient that is recognized by the system.

In FIG. 4, the “51” refers to fifty-one suggested ads sent and the “12” refers to twelve guided purchases. Section 224 can include details about how the user has been compensated from their activities on the system, such as revenues earned over particular time periods. For example, the graph in section 224 can represent revenues earned per month.

Another component of the account activity section 220 can be recent ad activity interface component 226 which displays information related to recent ad activity. Interface component 226 can include information about suggested ads that have been sent by the user including information about the product described in the ad, its cost and the recipient of the ad. The recent ad activity can be listed in a chronological order according to the time each suggested ad was sent.

The referral interface component 228 can include information about a referral rewards program where a user can earn rewards based upon the activities of other users that the current user has referred to the system. The interface component 228 can include information, such as how many individuals the user has referred, and the collective progress of these referred users towards rewards in the program. For example, the “12,” in 228 can indicate that the user has referred twelve users to join the interpersonal ad system. The “$15” can indicate that the twelve referrals have earned $15 dollars through activities within the system, such as successfully guiding purchases. The invite button can cause an interface to be generated that allows the user to invite another individual to join the system. The objectives section can include information about the referrals rewards program, such as the rules and objectives that lead to rewards, the rewards for meeting the objectives and information to indicate whether a particular reward has been earned.

The ad status interface component 232 can include information about each suggested ad that a user has sent. This includes: information about each ad, the ad recipient, a commission associated with the ad, whether a purchase has resulted from the ad and whether compensation has been received as a result of the purchases. A graphical status section can be provided. The information in the graphical status section can include an indication of one or more of 1) whether the ad was sent, 2) whether the ad has been clicked, 3) whether a purchase has been guided by the ad, 4) whether a commission for the ad is being processed, 5) whether a commission for the ad has been paid or combinations thereof.

In various embodiments, the account activity section 220 can include outputting one or more of interface components 222, 224, 226, 228 and 232. For example, a user can select to display only sections 226, 228 and 232 and the activity section 220 can be generated without interface components 222 and 224. In another embodiment, each of interface components 222, 224, 226, 228 and 232 can be expandable or collapsible. One or more buttons can be provided that when selected cause and associated interface component to collapse or expand. For example, in one state, the interface component 228 can be collapsed and a size of the account activity section 220 can be reduced. Then, a button can be selected that causes interface component 228 to expand and the size of the account activity section 220 can be expanded. Thus, via utilization of these buttons, a user can affect a format and presentation of components in the dashboard interface.

A number of selectable links can be located at the bottom of layout 200. In one embodiment, links to a privacy policy and terms and conditions are shown. A selection of the privacy policy link 234 can cause the system to display a privacy policy associated with the system. A selection of the terms and condition link 236 can cause the system to display terms and conditions that are associated with using the system.

Finally, a branding component 238 can be displayed in a lower left corner of the layout 200. In one embodiment, the branding component 238 can include a phrase associated with the system, such as “Send an ad. Get Paid™.” In this example, the phrase describes one aspect of the system that is important to a user.

### Presentation of Suggested Ads (Sent or Received)

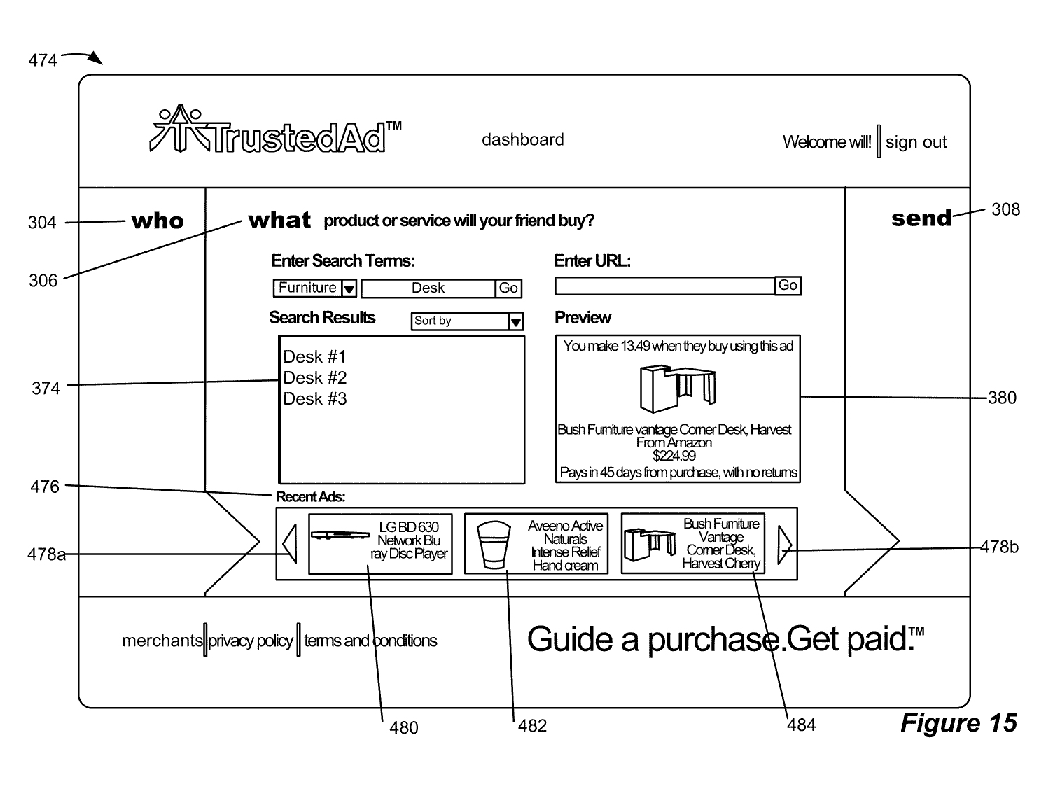

In this section, some details related to the presentation of suggested ads are described. In particular, FIG. 5 illustrates depictions of suggested ads received by the user that can be displayed in a user interface associated with the interpersonal electronic advertising system, such as a dashboard interface described above or an ad creation interface described below. FIG. 5 may similarly apply to ads sent by the user. Examples of displaying suggested ads sent by the user in an interface are described above with respect to FIG. 4 and below with respect to FIG. 15. Six suggested ads are shown in FIG. 5. However, as described above, the depictions of the suggested ads sent by the user or received from other users can be output such that only one suggested ad is displayed at one time or a number of ads can be output simultaneously and displayed at the same time.

In FIG. 5, six suggested ads, 256a-256f, that have been sent to a user of the interpersonal electronic advertising system, such as the user associated with the dashboard interface described with respect to FIG. 4 are depicted. Each of the received suggested ads identify the ad suggester that sent the suggested ad to the user. For example, ads 240a-240f, were created by “Lisa Public,” “Jane Smith,” “John Smith,” “Tom Smith,” “Katie” and “Bill Dunn.”

In one embodiment, each graphical depiction of a suggested ad includes who sent the ad 244, the operator 225 that enabled the suggested ad (TrustedAd™ in the example), an image representative of the product or service, a brief product description 246, a price 248, a selectable link 250 (“clicks for details” in the example) which when selected causes the system to display more information about the product and a selectable link 252 (“Click for purchase in the example) which when selected can direct the user to an interface that allows them to purchase the product identified in the ad. As examples, ad 240a includes a graphical depiction 242a of a blu-ray player, ad 240b includes a graphical depiction of a DVD player, ad 240c includes a graphical depiction 242c of a skin product (lotion), ad 240d includes a graphical depiction 242d of a computer desk, ad 240e includes a graphical depiction 242e of a jewelry piece (a necklace with a pendant) and ad 240f includes a graphical depiction 242f of a tire.

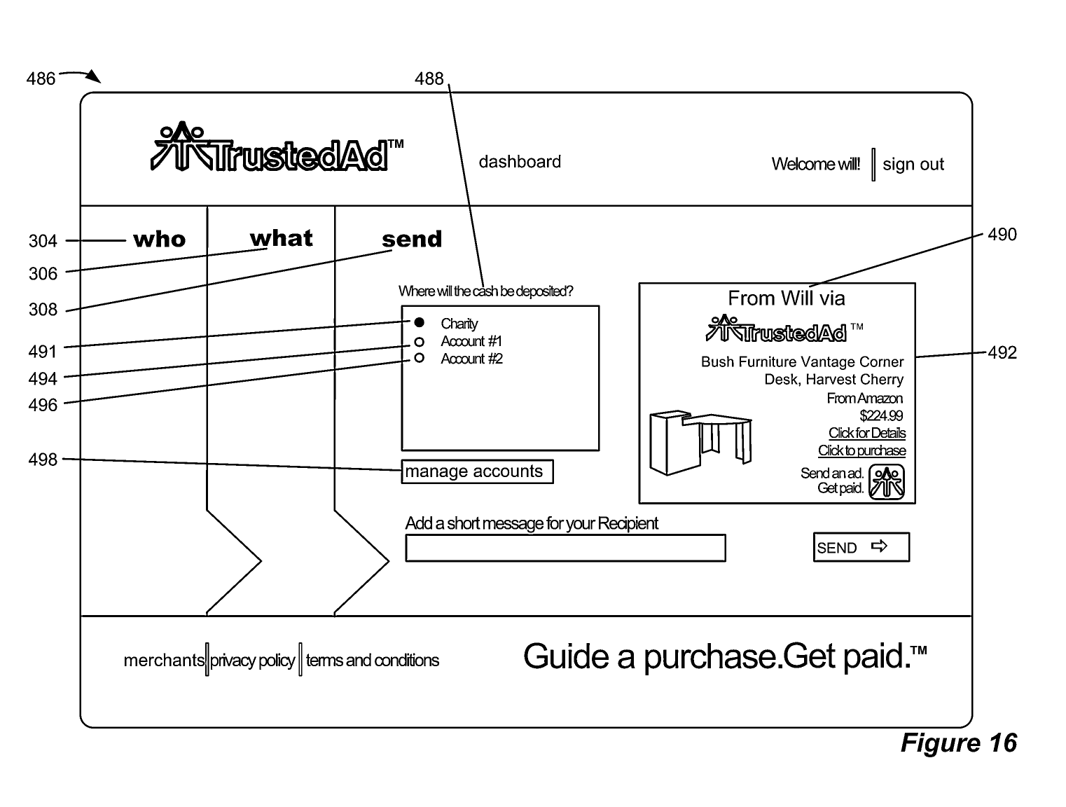

In other embodiments, additional elements can be added or removed from a graphical depiction of a suggested ad. For example, the graphical depiction may not include an image of the product. In another example, branding components (not shown), such as a logo and a text phrase associated with the operator can be displayed on the ads (e.g., “Send an ad. Get paid.”). In one embodiment, branding components, such as a logo and text phrase can be displayed in a bottom right corner of the depiction of the ad (see e.g., FIG. 16). Other for graphically depicting suggested ads can be utilized and the examples in FIG. 5 are for purposes of illustration only. For example, the components of the suggested ads shown in FIG. 5 can be arranged differently.

In FIG. 5, six suggested ads sent by the user are depicted simultaneously. In other embodiments, a maximum number of suggested ads that is greater or less than six can be displayed to a dashboard interface. In one embodiment, the system can be configured to accept user input that allows a number of suggested ads that are to be displayed simultaneously on a user interface, such as an ad creation interface or a dashboard interface to be specified. Others options that can be specified via the interface can include displaying only suggested ads sent by the user, displaying only suggested ads received from other user or displaying both suggested ads sent by the user and received from other users simultaneously.

As described above, the space available to depict suggested ads can accommodate a number of suggested ads that is less than a total number of suggested ads that are available for output to the dashboard interface. Further, the space that is available can vary from device to device. For example, more space can be made available for viewing suggested ads on a tablet computer as compared to a smart phone.

In one embodiment, to allow a user to view the suggested ads that are not shown, the interface can include the arrow buttons, 216 and 230. A selection of button 216 can cause all or a portion of ad 240a to disappear from the interface and cause all or a portion of a new ad to be shown below ad 242f. A selection of button 230 can cause all or a portion of ad 240f to disappear from the interface and can cause all or a portion of a new ad to appear above ad 240a. In another embodiment, a selection of button 216 can cause up to six suggested ads after ad 240f in a list of suggested ads to replace the suggested ads that are currently displayed and a selection of button 230 can cause up to six suggested ads preceding ad 240a in a list to replace the suggested ads that are currently displayed.

The use of buttons 216 and 230 is provided for the purposes of illustration only. An interface can be designed to accept a variety of inputs that allow the suggested ads to be moved in the manner described in the previous paragraph. For instance, using a touch screen interface, an upward or downwards motion detected on the touch screen can cause the suggested ads to scroll upwards or downwards. In addition, an interface can allow a user to select one of the suggested ads that are depicted and drag it upwards or downwards to scroll the list upwards or downwards. In yet another example, keys arrayed on a keyboard, such as arrow keys, can be used to move and/or scroll through a number of different suggested ads.

In FIG. 5, the suggested ads are depicted as orientated vertically on top of one another and can be scrolled in the vertical direction. In alternate embodiments, the suggested ads can be rendered horizontally in a side by side manner (e.g., see FIG. 15). The interface can be configured to accept inputs that allow the suggested ads to move in a horizontal manner including moving all or a portion of a suggested ad currently displayed off the interface and moving all or a portion of a suggested ad currently not displayed onto the interface.

In this example, the user can be named John Smith. As noted above, the user can send themselves a suggested ad. Thus, ad 240c may have been sent from John Smith to himself. Suggested ads 240b and 240d are sent from persons with a smith surname. In one example, the smith's can be family members of the user. For instance, Jane can be his wife and Tom can be his son.

In various embodiments, a suggested ad can be sent with a first name and last name, a first name only, a last name only or even a nickname. For example, Katie, in ad 240e, can be a nickname or a first name of the ad suggester. When a suggested ad is generated, an interface for generating the suggested ad can be configured to allow a user to specify how their name or nick name is to appear on the suggested ad. For example, a user may be known to a first ad recipient by their nickname and thus, the system can be configured to allow a user to specify their nickname when sending suggested ads to the first person. However, a second person may not know the user by their nickname. In this instance, the system can be configured to allow a user to specify an alternative, such as a more formal name.

### Ad Creation Interface Prior to Valid Login

In this section, a portion of an ad creation interface for generating a suggested ad in an interpersonal electronic advertising system is described. In one embodiment, an individual using the ad creation interface can generate a suggested ad prior to setting up an account with the system or logging into an existing account. The ad creation interface can be configured to offer one set of features prior to login and another set of features after a valid login. With respect to FIGS. 6-9 in this section, functions of the ad creation interface prior to a valid login are described. Additional functions of the ad creation interface that can be enabled after a valid login are described below in the section “Ad creation Interface after Valid Login” which includes FIGS. 13-17.

FIG. 6 illustrates a state 300 of an ad creation interface for an interpersonal electronic advertising system. In one embodiment, the ad creation interface can be accessed through a web-browser. When a user navigates to a URL (Universal Resource Locator) on the web from which the ad creation interface can be accessed, a web page with an arrangement as shown in FIG. 6 can be generated to a display. The web page can be generated by a server whereas the display can be associated with a number of different types of electronic devices, such as a smart phone, a tablet computer, a mobile device, an e-reader, a laptop computer or a desktop computer. A processor in the electronic device can be used to establish communications with the server and generate the browser interface. In another embodiment, the ad creation interface can be generated as part of a custom application executing on a users electronic device.

The ad creation interface can be layered with a number of sub pages that are navigable from state 300. In one embodiment, state 300 can be home or default state for the ad creation interface. Thus, the sub pages can include a selectable button that when selected returns the ad creation interface to state 300. For example, each of the sub pages can include logo 302. A selection of the logo 302 can cause the system to generate state 300 of the interface.

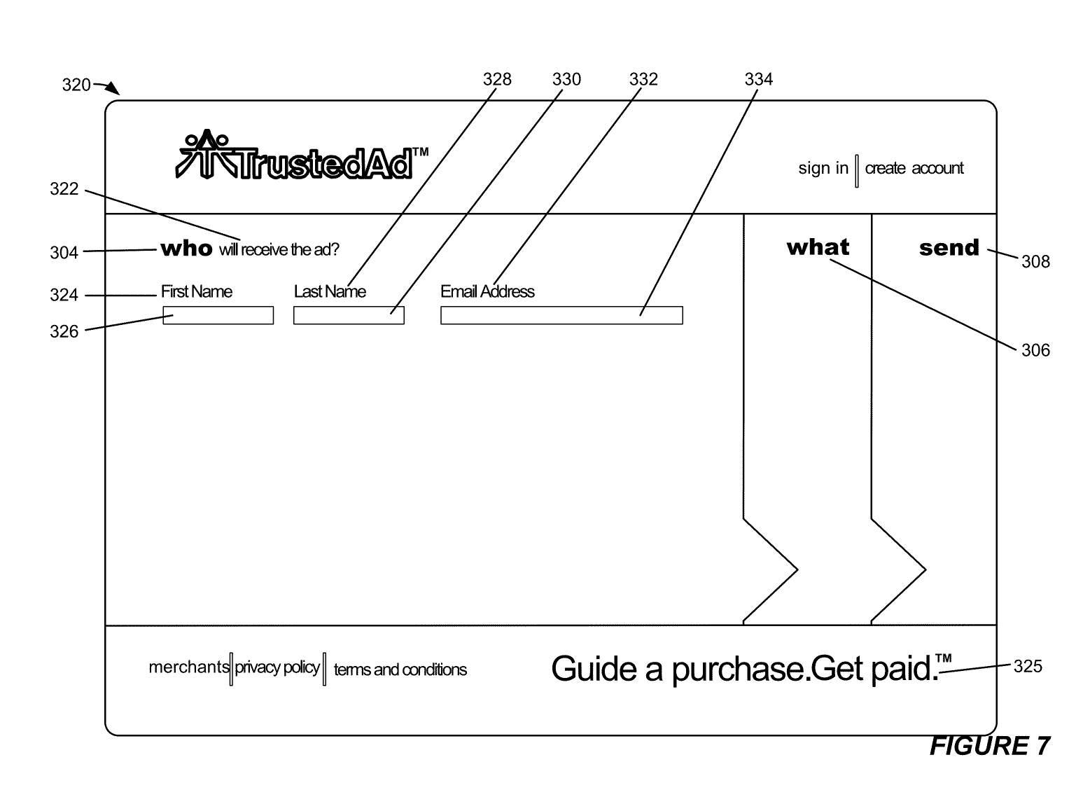

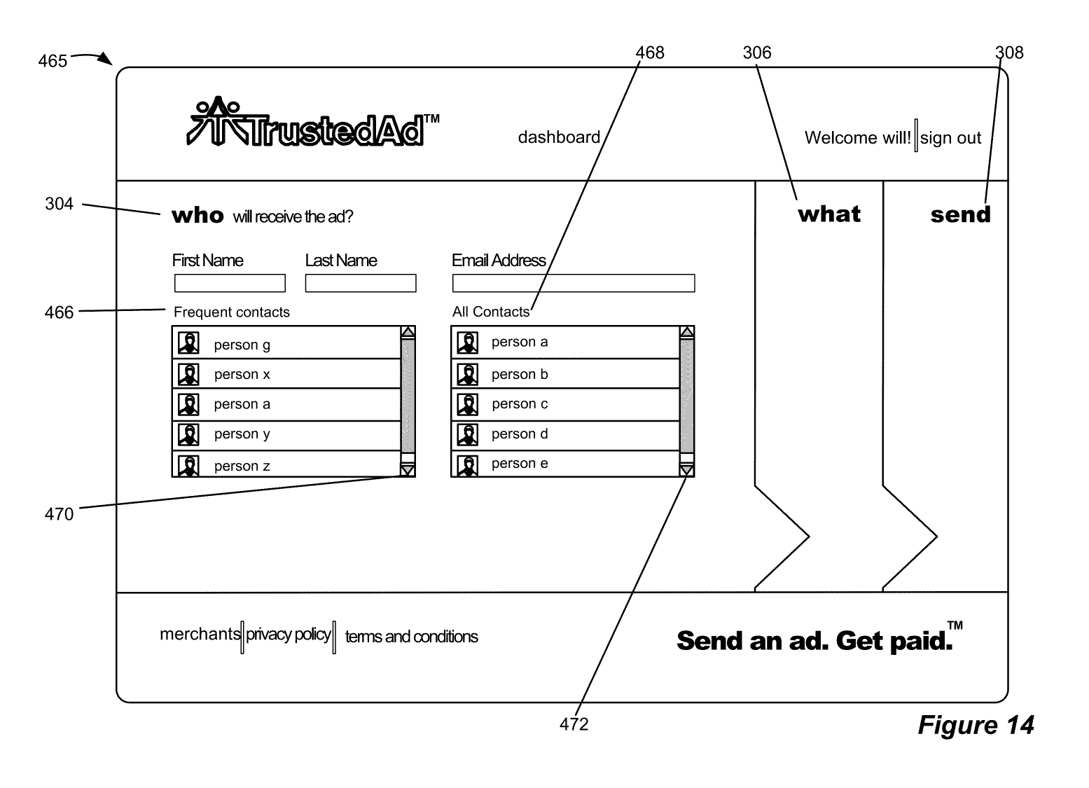

In one embodiment, interface can include 3 selectable tabs: a “who” tab 304, a “what” tab 306 and a “send” tab 308. When the “who” tab 304 is selected, a state of the interface can be generated that is configured to receive input specifying an ad recipient for a suggested ad. Further details of the state of the interface after the “who” tab 302 is selected are described below with respect to FIGS. 7 and 14.

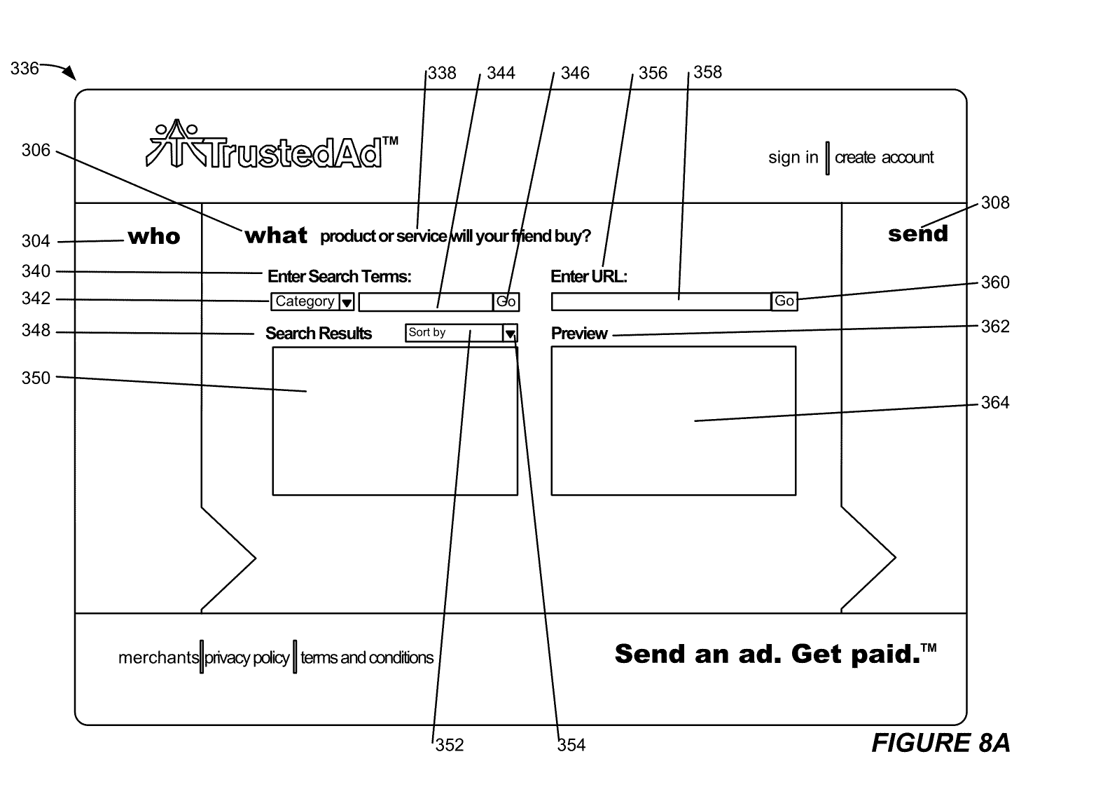

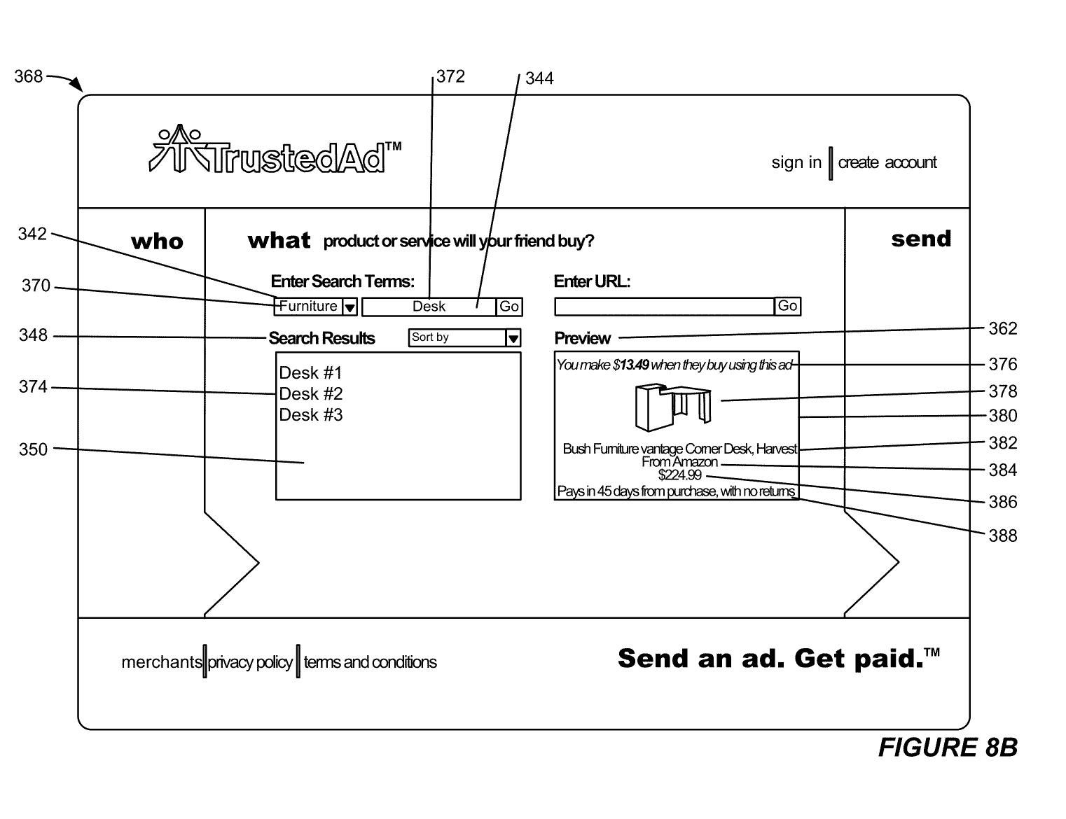

When the “what” tab 306 is selected, a state of the interface can be generated that is configured to receive inputs that cause the system to retrieve information related to various products or services. Via the “what” portion of the interface, a particular product or service can be selected and details related to a suggested ad that can be generated for the particular product or serve can be output. Details of the “what” portion of the interface are described below with respect to FIGS. 8A, 8B and 15.

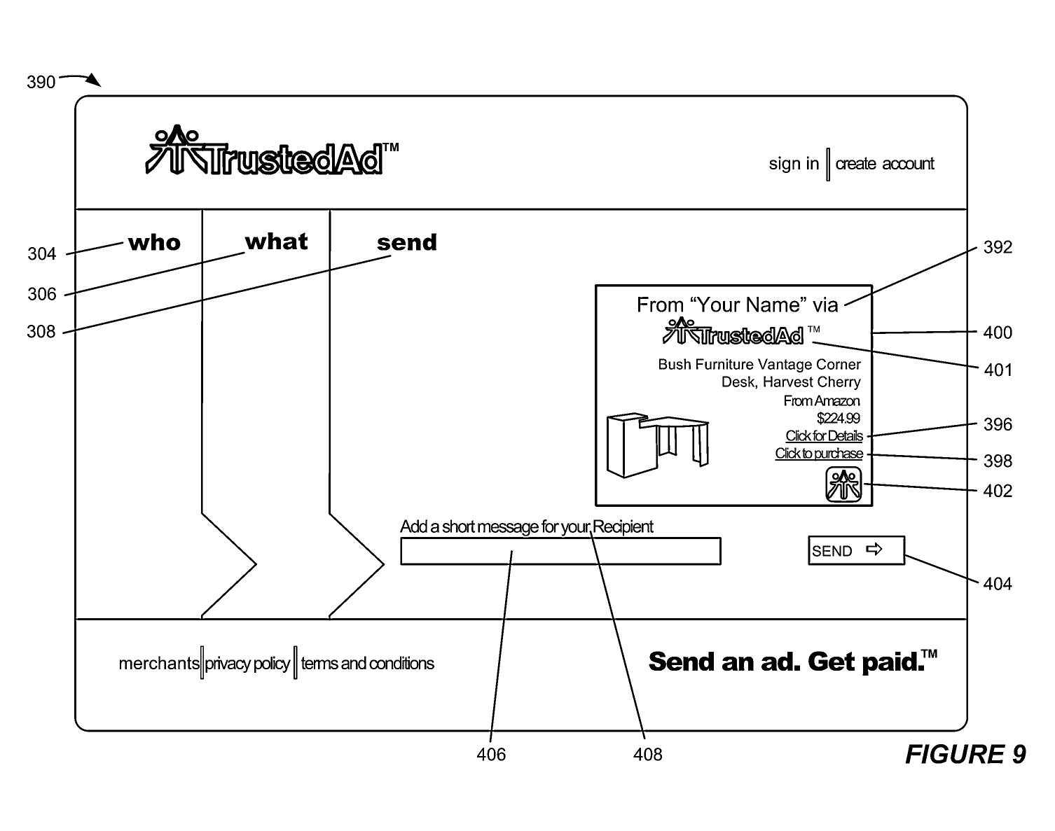

When the “send” tab 306 is selected, an image of a suggested ad that can be sent to ad recipient specified via the “who” tab 304 can be output via this portion of the ad creation interface. In one embodiment, the interface can be configured to accept input a personal message that can be optionally sent with the suggested ad. A send button can also be generated with this portion of the interface. When an activation of the send button is detected in the interface, the suggested ad and optionally the personally message can be sent to an ad recipient. Details of the “send” portion of the interface are described below with respect to FIGS. 9 and 16.

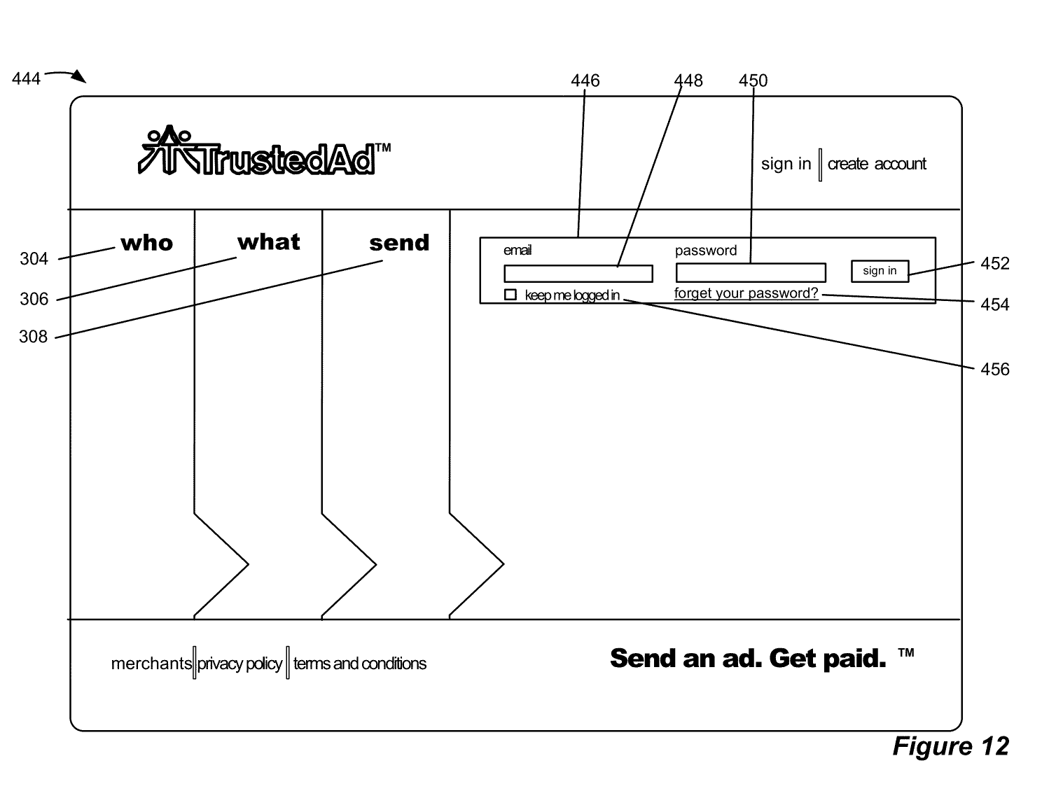

Returning to FIG. 6, “sign in” 310 can be a selectable button. A selection of button 310 can cause a state of the interface to be generated that allows login information to be input. After the login information is entered and validated, the interface can be coupled to an existing account on the system corresponding to the login information. An example of a state of the interface where login information can be accepted is described with respect to FIG. 12.

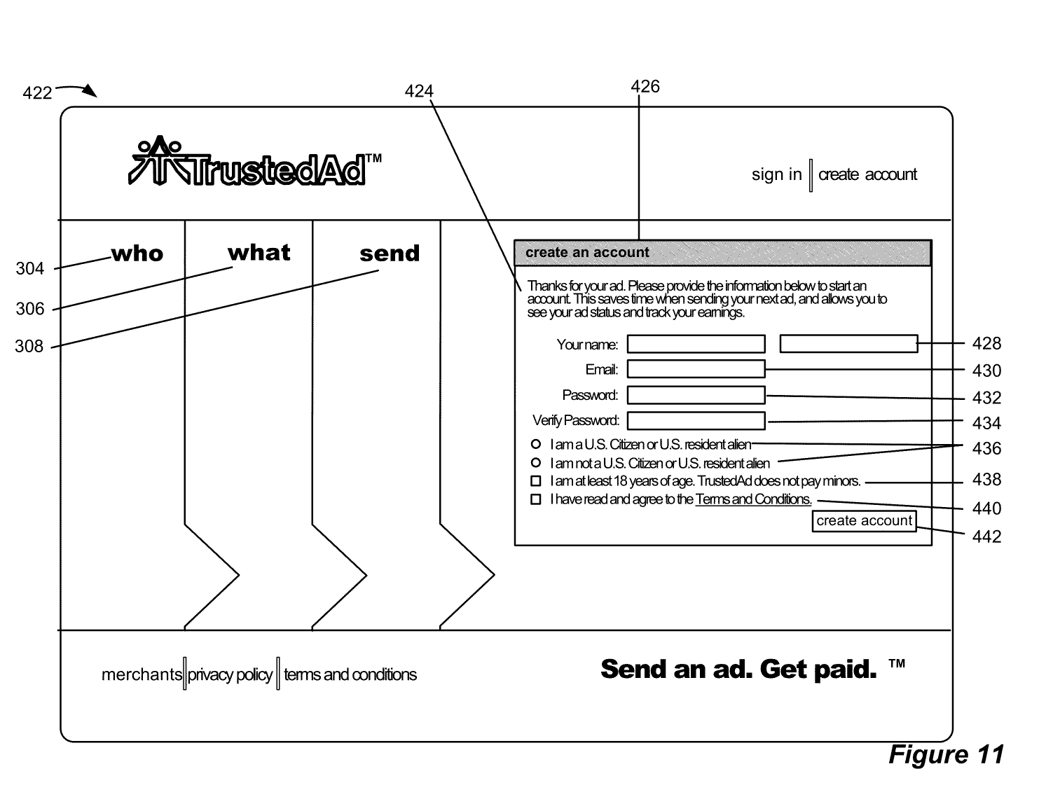

The “create account” 312 can be a selectable button. A selection of button 312 can cause the system to generate an interface that allows a user to register with the system. Upon successful registration, a new account can be created for the user and information relating to activities of the user on the system can be saved to the account. When a user logs out of the system and subsequently returns via a valid login, the system can retrieve previously stored information from their account. States of the interface that can be used to initiate a registration process are described below with respect to FIGS. 10 and 11. An example of a state of the interface that allows a registered user to login is described below with respect to FIG. 12.

A selection of the merchant button 314 can cause the system to generate states of the interface related to merchant services. For example, after selection of button 314, states of the interface can be generated that provide a merchant information about the interpersonal advertising system and accept information that allows a merchant to initiate registration with the system. In addition, a state of the interface can be generated that allows a merchant already registered with the system to log into their account. A few examples of interface states related to merchant services are described below with respect to FIGS. 18 and 19.

A selection of the privacy policy button 234 or the terms and conditions button 236 can cause the interface to output information related to the privacy policy or the terms and conditions associated with the system. In one embodiment, an interface state can include a branding component, such as 320.

In FIG. 6, the phrase “Send an Ad. Get Paid™” is displayed. The phrase can help to establish a brand or message or image that is associated with the operator of the site providing the interface.

FIG. 7 illustrates a state of an ad creation interface 320 for specifying an ad recipient for a suggested ad. When a user selects the “who” tab 302, the “who” tab can be expanded which causes the “what” 306 and “send” 308 to be slid horizontally over. In one embodiment, the selection can be made via an input to the area bound by the lines surrounding the “who.” As example, a selection can be made by 1) activating a touch screen above the area, 2) placing a cursor within the area and generating an input, such as a mouse click or 3) activating a key on the key board.

In state 320, the message “will receive the ad?” 322 is appended to the “who” such that the phrase “Who will receive the ad” is displayed. This phrase can help to guide the user in regards to what action is to be performed via the interface in this state. The words, “First Name” 324, “Last Name” 328 and “Email address” 332” are output. Via free text boxes 326, 330 and 334, below 324, 328 and 332, a user can enter a first name, last name and e-mail address of an individual that is to receive a suggested ad.

The e-mail address can be used by the system to contact the ad recipient. For example, an e-mail message including a suggested ad for the ad recipient can be generated and then sent to the e-mail address specified for the ad recipient in 320. In other embodiments, the interface 320 can be configured to accept alternate or additional forms of contact information. For example, the interface can be configured to accept a phone number of the ad recipient that can receive a text message. After the phone number is specified, the system can generate and send a text message including a suggested ad to the specified number. In yet another example, a postal mail address or second e-mail address can be specified.

In one embodiment, additional text boxes can be generated on 320 to receive other types of contact information, such as a number that can receive a text. In another embodiment, the “E-mail Address” can be an item in a pull down menu that lists different types of contact information that can be specified. When a particular item is selected, the interface can generate one or more text boxes that are compatible with the selected item. For example, a single input text box can be generated for entering an e-mail address or phone number but multiple input text boxes can be generated for entering a postal address, such as separate boxes for street address, city, zip code, state, country, etc.

In particular embodiments, the interface 320 can be configured to allow a user to input data without using a mouse. For example, upon initial navigation to 320, the text box 326 can be activated to accept input, such as input from a mechanical or virtual keyboard. Then via input buttons associated with the keyboard, such as arrow keys, tab, enter or backspace, activation of the different text boxes can be controlled. For example, when text box 326 is active, activating enter, tab or the right arrow key, can cause text box 330 to become active to accept input. From text box 330, activating enter, tab or the right arrow key, can cause text box 334 to become active to accept input whereas activating back space button or left arrow key can cause the text box 326 to become active. In addition, using a mouse, a cursor can be placed over each text box such that when an input is detected from the mouse or the keyboard the text box under the cursor when the input is detected becomes the active text box for accepting input.

FIGS. 8A and 8B illustrate states of an ad creation interface for selecting a product or service to use in a suggested ad. These states of the interface can be activated when a selection of the “what” tab 308 is detected. In this example, a selection of the “who” tab 304 is followed by a selection of the “what” tab 306 which is then followed by a selection of the “send” tab 308. The interface, however, is not limited to this order. For example, a user of the interface can select the “what” tab 306, first, and select an item for a suggested ad, then select the “who” tab 304 to specify an ad recipient and then select the “send” tab 308 to send the suggested ad. In a particular embodiment, the interface can be configured to accept the opening of the tabs in any order including opening a first one of the tabs, closing the first one and opening a second one of the tabs and then subsequently closing the second one and returning to the first one. In another embodiment, the interface can be configured to not expand the send “tab” 308 until information has been entered via the “who” tab 304 or the “what” tab 306.

In one embodiment, interface can be configured to open only one of the tabs, 304, 306 and 308 at one time. Thus, a selection one of the tabs causes another tab that is open to be closed. In addition, the interface can configured such that a selection of a tab that is open can cause it close so that all of the tabs can be closed simultaneously. In another embodiment, the interface can be configured to allow two or more of the tabs to be opened simultaneously, such as but not limited to the “what” tab 306 and “send” tab 308 or the “what” tab 306 and “send” tab 308. In alternate embodiments, more than three or less than three tabs can be provided on the interface.

When the “what” tab 306 is selected when the “who” tab 304 is open, the “who” tab 304 can close, the “what” tab 306 can expand and the “send” tab 308 can be shifted to the right horizontally to generate interface state 336. The text “product or service will your friend buy” 338 can be appended to the “what” to generate the message “what product or service will your friend buy.” This message can guide the user in regards to what action they are to perform when the “what” tab 306 is open.

The text “Enter Search Terms:” 340 can be displayed and a text box for receiving input 344 can be generated beneath it to receive search terms that are entered. The terms that are entered can be descriptive of a desired product, such as “desk.” After the user selects button 346, the search can be initiated. An example of a state of the interface after a search for a “desk” is described as follows with respect to FIG. 8B.

In one embodiment, the interface can be configured to accept inputs that limit a scope of the search. For example, products and services can be grouped according to categories and the search can be limited to one or more of the categories. Thus, the interface can be configured to receive input of a selected category. In one embodiment, input to limit a search can be specified via a pull down menu, such as 342. When the pull down menu is selected, a list of categories can be displayed, such electronics, books, music, clothes, furniture, etc. In addition, the category “all” can be selected. From the pull down menu, a particular category can be selected from the list to limit the search to within the selected category. The “all” category can be selected to search among all of the categories. The “all” category can be the default category so that the search is not limited when a category is not selected by the user.

The text “search results” 348 can be displayed on the page. Beneath the text 348, a box 350 can be provided in interface 336 for outputting the search results matching the specified search terms. In one embodiment, the search results can be output in a text format as a list of different products including a brief description of the product. In another embodiment, the search results can be output graphically including a small image of each product and possibly a limited amount of text. In one embodiment, the interface can be configured to receive an input that allows the user to specify how many search items are to be displayed at one time on interface 336. When the number items that can be displayed at one time is less than the number of items returned from the search, one or more search items may not be displayed on the interface 336. The interface can include selectable buttons that allow search items currently displayed to be removed and search items not displayed to be added so that the user can see all of the items from the search.

In one embodiment, the interface 336 can be configured to receive input that enables sorting of the items returned from a search. For example, a pull down menu 352 can be provided. The pull down menu can include a number of sorting options, such as highest to lowest price, lowest to highest price, highest to lowest commission value, etc. After one of the sort options is selected, the button 354 can be activated. In response, the search items displayed in 350 can be rearranged according to the selected sorting option. In one embodiment, highest to lowest commission value can be the default sorting option.

The interface 336 can be configured to accept a selection of one of the items return from a search. For instance, a user can place a cursor over the search item and then generate a mouse click to select it. Details of the selected search item can be displayed in box 364 beneath the text “Preview” 362. An example of a preview for a product selected from among items returned from a search is described as follows with the respect to FIG. 8B.

One way that a user can locate a product that they wish to send to an ad recipient can be via search implemented by an electronic device, such as a server or group of servers, outside of the interpersonal electronic advertising system. For example, the individual can use a search engine, such as Google™ or Bing™, to navigate to a web page that displays a desired product. In one embodiment, the interface 336 can be configured to accept a URL (Universal or Uniform Resource Locator) determined from the outside search. The URL can be entered in the text box 358 via the text “Enter URL:” 356.

After a URL is entered, the user can select the “go” button 360. A selection of the “go” button can cause the system to go the page specified by the URL and attempt to locate product information displayed on the page. In one embodiment, the product information can be located by parsing the mark-up language coding for the page. If product information is located, then the system can implement a search of its product database to determine if a match to the product or a similar product can be found in the system. In addition, the system can communicate with a third-party system to determine if product information can be obtained. If a match is found, the item can be displayed in the search result box 350. Then, the item can be selected which can cause a preview of the item to be displayed in the preview box 364.

In some instance, a specified URL can display information related to multiple products. When multiple products are identified, the system can perform a search to locate each of the products in its internal databases or the external databases accessible to the system. When multiple search items are found that match the product, the search items can be displayed in 350. The user can then select and examine a preview of the selected item in preview box 364 to determine whether the product they identified in the specified URL has been located by the system.

In FIG. 8B, a state 368 of the ad creation interface after a search has been implemented, a list of search items has been returned and one of the search items has been selected is shown. In FIG. 8B, a search for a desk has been implemented. In more detail, the search term “desk” 372 has been entered in the search box 344, the category “furniture” 370 has been selected from the pull down menu 342 and a search has been initiated (e.g., via activation of the “go” button). The search has returned three items, “Desk #1,” “Desk #2,” and “Desk #3.”

The system can include an internal database with information about a large number of databases. In one embodiment, the search can be carried out only within the system's internal database. The system may also access external product databases maintained by another entity. For example, Amazon.com® allows searches of its product databases via an API (Application Program Interface). The interpersonal electronic advertising system can send the search terms it has received to a third-party and in response receive search results matching or suitably resembling the search terms. The third-party search results can include enough information to allow a list of candidate products to be generated and returned via the API. In one embodiment, for a particular search, the system may interact only with third-party systems to obtain search results. In another embodiment, the system may interact only with an internal database to obtain search results. In yet another embodiment, the system can search internally and interact with one or more third-party systems to obtain search results.

In FIG. 8B, the second item 374 (Desk #2) has been selected from the search results and a preview of the selected item is output below the text “Preview” 362 in the format 380. Based upon the price of the object and details of the individual that has selected the item a commission that can be earned is determined. As described above, based on their activities within the system a first individual can earn a greater or smaller commission from a suggested ad than a second individual for the same suggested ad. Thus, the system can be configured to account for the individual that has selected the suggested ad in determining the commission.

In this example, a user has not signed in and may not even be registered with the system yet. When the user has not been identified, the system can utilize a default method for determining the commission. For instance, the default method may be multiplying the price of the product by some default percentage as determined by a relationship with the Merchant selling the product, such as 5% or 6%. The method for determining the default commission can vary from product to product and merchant to merchant. Thus, the commission shown for a particular product can vary depending on whether the user has an active account and whether the user is logged into the system to allow the system to access their account information.

In FIG. 8B, the message “You make $13.49 when they buy using this ad” 376 is displayed in the preview box. The $13.49 is the commission estimated for the product. In the interface, the commission value, $13.49, can be emphasized in some manner. For instance, the text associated with the number can be in a different font than adjacent text, such as bolded, or the number can be a different color than adjacent text.

Below the message 376 an image of the product 378 and a brief product description 382 is shown. In this example, the desk is described as a “Bush Furniture vantage Corner Desk, Harvest.” Below the product description, the message “From Amazon” 384. The message 384 indicates that the product is sold on “Amazon.com.” The product may have been found via a search of Amazon's database in response to a search request by the system. The price 386 of the item is indicated as $224.99.

Beneath the price is information indicating terms associated with the suggested ad. The terms can be specific to a particular ad suggester, ad recipient, product, merchant, period of time, etc. In one example, the terms indicate when the individual selecting the item and sending the suggested ad can expect payment after a purchase is guided from the suggested ad. In this example, the merchant that sells the item (Amazon.com™) pays 45 days after a purchase guided by the suggested ad. The “no returns” portion of the message 388 indicates a commission is not earned if the item is returned after purchase.

Multiple merchants can sell the same product where both are registered with the system. For example, two different merchants with an on-line presence can sell the desk 380. Thus, when a search is implemented, multiple instances of the same product from different merchants can appear in the search results. In one embodiment, the interface can be configured to indicate multiple instances of the same product to the user. For example, the multiple instances of the same product can all be highlighted with a common color. In another example, when a user selects one search item which is one of a multiple instance of a product, the other instances of the same product can be highlighted in some way.

Using the interface, the user can preview the multiple instances of the same product which can appear in different ads. A few examples of the differences from ad to ad for the same product can be the 1) the merchant name (e.g., amazon), 2) the commission offered by the merchant (e.g., a first merchant can offer $13.49 as shown while a second merchant can offer $15 dollars), 3) the price of the item (e.g., a first merchant can offer the item for $224.99 dollars while a second merchant can offer the item for $200 dollars) or 4) when the merchant pays (e.g., a first merchant pays in 45 days while a second merchant pays in 30 days). By comparing the suggested ads for the same product, the user can decide which suggested ad to send. For example, a user can choose a first suggested ad over a second suggested ad because the commission is higher, or it pays sooner. As another example, the user may have particular experience with a merchant that they prefer and their ad over another's merchant's ad. In another example, the user may choose the merchant with the lowest price because they believe it will be more likely to lead to a purchase.

In a particular embodiment, the “what” tab 306 can include a comparison feature. The comparison feature can allow a user to select any two or more different ads that can be viewed simultaneously. Thus, the suggested ads can be for two or more instances of the same product, two or more related products (e.g., two different desks) or two or more different products (e.g., a desk and jewelry). With the ads displayed in a side-by-side manner, the user can determine which ad to select.

As an example, the interface can include an image of an open box which is selectable. The interface can be configured so that the user can select and drag a search item over the box. This action can cause the system to store information about the search item. Then, when the box is selected, a pop-up window can appear and suggested ads for any search items stored to the box can be displayed in a side-by-side manner in the window.

FIG. 9 illustrates a state of an ad creation interface for previewing and sending a suggested ad in accordance to one embodiment. The interface state 390 can be generated by selecting the “send” tab 308. When the “send” tab 308 is selected, the tab 308 can expand and if other tabs are open, such as 304 and 306, these tabs can be closed.

In one embodiment, the “send” tab 308, in its expanded state, includes the text “Add a short message for your Recipient” 408. Below the text 408 is the text box 406. When the text box 406 is activated, it can accept input that allows the ad suggester to personalize the suggested ad that has been selected. For example, the message might say, “I got this for my spouse and they loved it.” The specification of a personal message is optional and suggested ads can be sent without personal messages.

The “send” tab 308 can include a space 400 for displaying a suggested ad, such as an image of the suggested ad that is going to be sent. If a product hasn't been selected via the “what” tab 306, then space 400 can be blank. In this example, the desk previewed when the “what” tab 306 is open, as described with respect to FIG. 8B, is displayed as a suggested ad.

The suggested ad includes a name 392 of the ad suggester. Typically, the ad suggester will specify their name when they register for an account with this system. The system can retrieve their name after a successful sign in. In this example, the ad suggester isn't signed in yet. Thus, the place holder, “Your Name” is displayed in the suggested.

The suggested ad includes an image of the product, brief product description and merchant name. These components are also displayed in the preview box of “what” tab 306 shown in FIG. 8B. However, the arrangement of information in the preview box of FIG. 8B is different than the arrangement of information shown for the suggested ad in FIG. 9. The suggested ad can be output such that it includes selectable buttons or links. For example, “Click for Details” 396 and/or “Click to purchase” 398 can be selectable buttons or links. A selection of “Click for Details” 396 can cause an application outputting the suggested ad to display more details about the product. In one embodiment, a selection of the “Click for Details” 396 can cause a web-browser to navigate to a web page where details about the product are displayed.

A selection of “Click to purchase” 398 can initiate a purchasing process. For example, if the suggested ad is sent an e-mail, a selection of 398 can cause a browser application to launch. After launch, the browser application can open to a page, such as a merchant web page displaying the product in the suggested ad. As described above, a suggested ad can be associated with a particular merchant. From the merchant web-site including the merchant web page, the ad recipient can make a purchase of the product.

The suggested ad can include branding, such as logo 402 and the “TrustedAd™” logo 401. These items can also be selectable. Thus, when the suggested ad is received by an ad recipient and displayed the ad recipient may be able to select each of the logos. In one embodiment, a selection of the logo 401 or 402 can cause an application, such as a web-browser, to navigate to a web-page, such as the ad creation interface 300 in FIG. 6. In another embodiment, a selection can cause an application to navigate to a web-page that provides registration at the operator site from which the suggested ad originated. Thus, the ad recipient can be encouraged to begin sending suggested ads. In another embodiment, the suggested ad can include a selectable button (not shown) with text, such as “Register Now to send ads and get paid.” A selection of the button can cause an application to navigate to registration web page or launch another application in which the navigation web page can be displayed.

After entering a personal message if desired, the send button 404 can be selected. The interpersonal ads use the name and identification of the ad creator to create a positive reception for the ad recipient. Since a sign in has not taken place, the person that has created the suggested ad may be unknown to the system. In one embodiment, prior to sending the suggested ad that is output in 390, the interface can request the ad suggester that provided the input to generate the ad to sign into the system if they have previously registered for an account or register for a new account. An example of the interface in this state is described below with respect to FIG. 10.

### Account Registration and Login

FIG. 10 illustrates a portion 410 of an ad creation interface for directing a user to sign-in or register for an account. In this state, the “who” tab 304, the “what” tab 306 and the “send” tab 308 are closed. In one embodiment, this state of the interface can be generated after an attempt to send a suggested ad prior to the ad suggester signing into the system is detected, as described above with respect to FIG. 9.

In response to detecting that an attempt has been made to send a suggested ad where the ad suggester is not known to the system, a message that requests the ad suggester to identify themselves can be output. For example, message 412, “Your ad works better when the ad recipient knows who is guiding the purchase” where the ad suggester is the person guiding the purchase. Below message 412, the message 414, “Already have an account?”, is output. Below message 414, a selectable button 416 which includes the text “sign in” is displayed. A selection of this button can cause the interface to generate a state that allows a user with an existing account to sign into the system (e.g., see FIG. 12).

A message 418, which states, “Start an Account” can be displayed to indicate to a non-registered user that they can open an account. Beneath the message 418, a selectable button 420 is displayed. The selectable button is labeled with the text “quick sign up.” A selection of this button can cause a state of the interface to be generated where a registration process can be initiated. An example of an interface state that is configured for registration is described as follows with respect to FIG. 11.

FIG. 11 illustrates a state of ad creation interface in a state 422 for generating a new user account. The ad creation interface can include selectable buttons that are output in one or more different states that when selected can cause interface state 422 to be generated. In addition, selectable registration buttons can be embedded in other locations, such as merchant web-sites, within suggested ads that have been sent to ad recipients or within an e-mail messages that have been sent to an ad recipient. In response to a selection of a registration button, an application executing on an electronic device can navigate to web-site or interact with a remote server to generate a registration interface, such as 422.

In one embodiment, the registration interface 426 can be displayed next to the “who,” “what” and “send” tabs in their closed states. The registration interface includes the title, “create an account.” Beneath the title, a message 424 can be displayed. The message can reflect the context from which the registration has been triggered. In this example, the registration has been triggered after an individual has attempted to send a suggested ad without identifying themselves. Thus, message 424 states, “Thanks for your ad. Please provide the information below to start an account. This saves time when sending your next ad, and allows you to see your ad status and track your earnings.” If 422 is generated from another context, such as a selection of a registration button in a received suggested ad, then the message can be different. For example, the message might say “You too can send ads and get paid.” instead of “Thanks for your ad.”

To initially register, one or more text boxes for a name 428, an e-mail address 430, a password 432 and a verification of the password 434 are provided. In different embodiments, the interface state 422 can be configured to accept other types of information, such as an input of phone number where a text can be sent, an address or a login name that they can use with the system. In 436, a user can specify, by selecting a circle, whether they are a U.S. Citizen or a U.S. resident alien or not.

In addition, the system can have an age requirement. For example, in 438, it states “I am at least 18 years of age.” Prior to completing their registration, the interface may need to receive a selection of the box in front of the age related message. Next, in 440, a message that states, “I have read and agree to the Terms and Conditions” is displayed. The terms and conditions can be selectable such that a selection causes the interface to display the terms and conditions for using the service. Prior to completing their registration, the interface may need to receive a selection of the box in front of the “terms and condition” message.

A selection of the create account button 442 can cause the system to parse the information that has been input. If the information that has been input is completed, a new account can be created and the user can be notified of the new account. The notification can be the display of a message in 422, such as “account successfully created.” In addition or in lieu of displaying a notification message in the interface, a message can be sent to the e-mail address that has been entered. Further, a successful registration can cause a state of the interface after “sign in” to be generated. For example, state 458 in FIG. 13 can be generated.

If the information that has been input is not complete, the interface can output an indication of the needed information that is needed. For example, if an e-mail address hasn't been specified, then the text, “Email:” and its adjacent input box can be highlighted. As another example, a message, such as “please provide your Email as it will be used to sign into the system,” can be output.

FIG. 12 illustrates a state of the ad creation interface for signing in a user with an existing account. Interface state 444 can be generated in response to a selection of the “sign in” button 416 shown in FIG. 10. In addition, interface state 444 can be generated in response to a selection of the “sign in” in the upper right corner of the interface as shown in FIGS. 6-10.

In interface state 444, the “who,” “what” and “send” tabs are in a closed position. Adjacent to the “send” tab 308, a “sign in” box 446 is provided. The box 446 includes a text box 448 for entering the e-mail address that was specified during the registration process and a text box 450 for entering the password. A selectable button “sign in” 452 is provided to initiate to sign into the system after the e-mail address and password are specified. An option of allowing the user to remain signed is provided via a selectable box 456. In addition, a selectable link 454 is provided that initiates a remedial action if the user has forgotten their password.

Ad Creation Interface after Valid Login

In this section, states of the ad creation interface after a sign in procedure has occurred are described and contrasted to the states of the ad creation interface prior to sign in that have been previously described above with respect to FIGS. 6-10. FIG. 13 illustrates a home state 458 of an ad creation interface for a signed in user. As compared to the non-signed in home state in FIG. 6, a selectable link 460 is provided. A selection of link 460 can cause a dashboard interface to be generated. An example of the dashboard interface is described above with respect to FIG. 4. In addition, instead of “sign in” and “create account” being displayed in the non-signed in state, the messages, “Welcome Will” 462 and “sign out” 464 are displayed. In 462, “Will” can be a first name specified in the account creation process. A selection of 464 can cause the interface to return to a signed out state as previously described.

Next, differences between the signed in and signed out state for “who” tab 304, the “what” tab 306 and the send “tab” are described with respect to FIGS. 14, 15 and 16, respectively.

FIG. 14 illustrates a state 465 of an ad creation interface for specifying an ad recipient for a user signed into an interpersonal electronic advertising system is described. State 465 can be generated when the “who” tab has been selected.

In one embodiment, the system can be configured to store contact information for a signed in user. The contact information can include previously specified ad recipients of suggested ads. In one embodiment, the contact information only includes the previously specified ad recipients. In other embodiments, the system may allow a user to import contacts into the system from another application. In yet another embodiment, the system may require that all contacts to be entered manually via the input boxes provided in 465. This requirement may discourage spamming.

In 465, two groups of contacts, frequent contacts 466 and all contacts 468 are displayed. In alternate embodiments, no contacts, one group of contacts or more than two groups of contacts can be displayed. A group can include all or a portion of the user's contacts. Further, the interface can be configured to create and specify different groups. For example, a user could create a group called family members that included all of the user's family members. A group can include more members than can be displayed at one time on the interface. In one embodiment, to scroll through a group, controls, such as 470 and 472, can be provided.

The contacts in each group can be sorted in some way. For example, the “all contacts” group 468 can be sorted alphabetically. The frequent contacts group can be all of the user's contacts sorted according to the number of times the contact has been an ad recipient. In another example (not shown), a most recent contacts group can be displayed. The most recent contacts group might include all of the ad recipients for suggested ads the user has sent over the past week. This group might be sorted according to the time between when the contact received a suggested ad and the current time.

When a first contact is selected, the text input boxes under “First Name,” “Last Name” and “Email address” can be auto-populated. If a second contact is selected, then the input boxes can be auto-populated with the second contact. One advantage of using the contacts feature is that a user can specify an ad recipient without having to input any text, i.e., an ad recipient can be specified via one or more clicks, which reduces the time for a user to enter an ad recipient. In one embodiment, the system can be configured to allow a user to specify a group of individuals that are to receive a common suggested ad. In this embodiment, the system can be configured to allow a user to select multiple contacts that can be used populate group that is to receive the suggested ad.

FIG. 15 illustrates a state 474 of an ad creation interface for selecting a product or service to use in a suggested ad for a user signed into the interpersonal electronic advertising system. When a user has signed in, suggested ads that they have previously sent, such as recent ads 476, can be displayed. In this example, suggested ads for a blu-ray player 480, lotion 482 and a desk 484 are displayed. To view other ads that user has previously sent but are not displayed, navigation tabs 478a and 478b are provided.

In one embodiment, when a user selects one of the recent ads, the preview section 380 can be populated. For example, ad 484 for the desk may have been selected instead of the one the items returned from the search results. When a recent ad is selected, the system may check to determine if the ad is still valid and whether the information on the ad has changed. For example, if the merchant for ad 484 no longer sells the selected product, then this ad would no longer be valid. The system can notify of the user that the ad is no longer valid and/or if available return one or more other ads for the same or similar product.

As described above, information on the ad may have changed from the first time the user created the ad. For instance, the price for the product may have gone up or down, the commission may have gone up or down, or the time that the merchant pays may have gone up or down. This information can be updated in the preview section. In addition, in one embodiment, the system can be configured to notify the user of any changes from when they first selected this product and created the ad. For example, if the price has gone up a message can be displayed stating the price has gone up and the amount it has gone up.

One advantage of using the recent ads 476 is that the user can specify the product for the ad without having to type in any input. Using a mouse or some other selection mechanism, such as a touch screen, a user can scroll through their previously sent ads and efficiently select one of the ads. Information about the selected ad can be displayed in the preview box.

FIG. 16 illustrates a state 486 of an ad creation interface for previewing and sending a suggested ad for a user signed into the interpersonal electronic advertising system. The state 486 can occur after a user has signed in and then selected a suggested ad to an ad recipient. As compared to 390 in FIG. 9, one difference in 486 is that the suggested ad 492 includes the name 490 of the account holder that is signed into the system. In this example, the name associated with the account is “Will.” In 486, the first name is displayed. In other embodiments, the first and last name, the last name only or a nick name can be displayed on the suggested ad 492. The interface can be configured to allow a user to specify a name as it is to appear on the suggested ad 492.

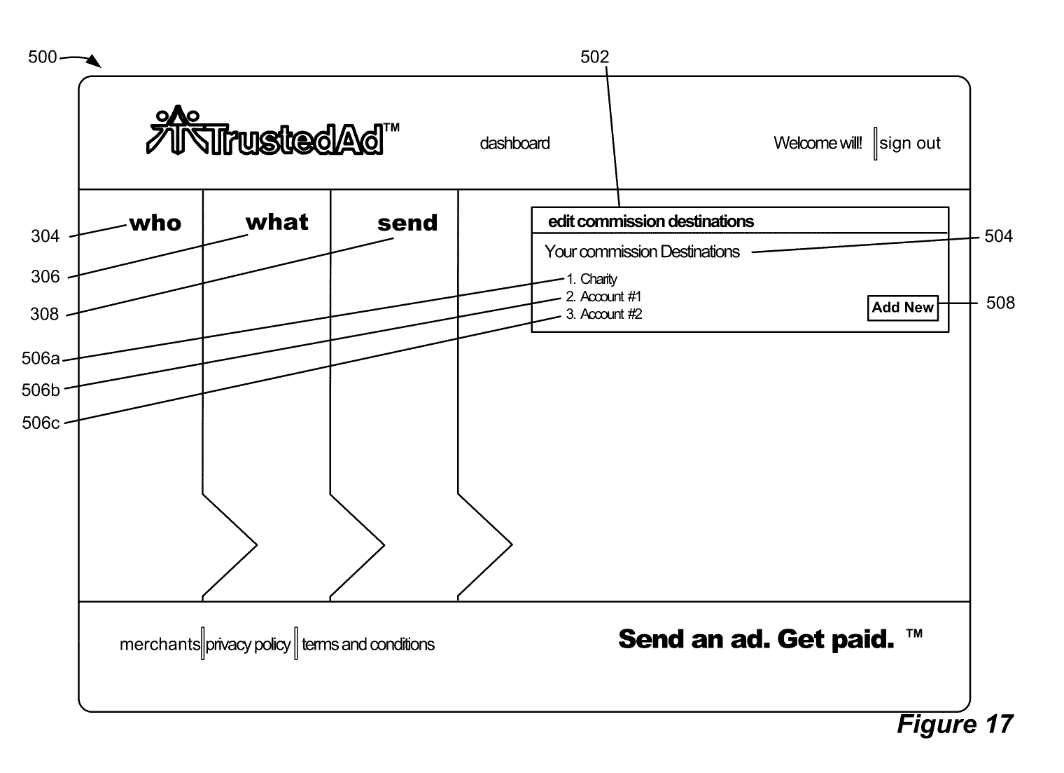

Another difference in 486, as compared to 390 in FIG. 9, is that the interface is configured to allow a user to specify a payment destination for the suggested ad. The user can enter payment information during the registration process or while actively using the interface. For example, a selection of the “manage accounts” button 498 can cause a state of the interface to be generated where a user can add and edit their existing payment destinations. More details of this interface are described below with respect to FIG. 17.

In 486, the message 488 “Where will the cash be deposited?” is displayed. Below message 488 three payment destinations, a charity 491, account #1 494 and account #2 496 are displayed. A selectable circle is next to each payment destination. In the 486, the charity has been selected as the payment destination. Thus, if a purchase is guided from the suggested ad 492, a commission that is earned can be sent directly to the charity after it is received from a merchant.

After the suggested ad is sent, the payment destination can be changed. In one embodiment, the payment destination for the suggested ad can be displayed in the user dashboard interface (see FIG. 4). A selection of the payment destination can cause an interface state to be generated where a new payment destination can be designated for an ad that has been sent but not yet paid by the system.

FIG. 17 illustrates a state 500 of ad creation interface for modifying or adding a payment destination. In 500, a box 502 with the title “edit commission destinations” is displayed to right of the “send” tab 308. In this example, the “who,” “what” and “send” tabs are in a closed state. Beneath the message “Your commission destinations” 504 three existing payment destinations, 506a, 506b and 506c are listed. In one embodiment, a selection of the one the payment destinations, 506a, 506b and 506c can cause an interface state to be generated where the payment destination can be modified or deleted. A selection of the “Add New” button 508 can cause an interface state to be generated where information associated with a new payment destination can be entered.

### Merchant Participation

In this section, a few states of the interface are described that can occur after a user selects “merchants” in a bottom left corner of the interface as shown in FIGS. 6-17. As described above, a suggested ad can be associated with a particular merchant. Before a merchant can offer the products or services for suggested ads, the operator of the interpersonal electronic advertising system can establish a relationship with the merchant. The relationship can involve one or more of agreeing to what products can be advertised on the site, a commission structure, how funds are to be transferred between the merchant and the operator, when payments for guided purchases are to be made by the operator, how the operator obtains suggested ads from the merchant, terms and conditions for being on the system, etc.

FIG. 18 is an interface state 510 that can be generated after “merchants” 314 is selected. In this example, the merchants 314 has been selected from an interface state where a user is not signed into the system. Thus, the “sign in” and “create account” are displayed in the upper right hand corner. In 510, a box with two active buttons is generated next to the left send tab. The “who,” “what” and “send” tabs are closed. Below the message “Already have an account?” 512, a “sign in” button 518 is generated. A selection of the “sign in” button 518 can cause the system to generate an interface state that allows a merchant with an existing account to sign into the system.

Below the message “Create a Partnership” 514, a “quick sign up” button 516 is displayed. A selection of button 516 can cause an interface state to be generated where a merchant can initiate a registration process with the system. An example of an initial registration state is described as follows with respect to FIG. 19.

FIG. 19 illustrates an interface state 520 configured to accept information that allows a merchant to initiate a registration process with the system. A box 522 with the title “Let TrustedAd™ bring revenue to your business” is generated to the left of the “send” tab 308. Below the title, message 524 is displayed. It states, “Thank you for your interest in permitting TrustedAd's Ad senders to guide Purchasers to your business! Personal connections drive sales, and TrustedAd has the connections. Please provide the information required below and a member of the TrustedAd will contact you.”

Below message 524, a number of input boxes are displayed. The input boxes allow the entry of a company name 526, a company URL 528, a name 530, a phone number 532, an email address 534, a password 536 and a password verification 538. After the specified information is input, the next button 540 can be selected. After the selection of button 540 is received, a message, such as “Thanks ‘entered name’ for your information. A system representative will be contacting you soon.” can be generated.

### Method for Generating Suggested Ads

FIG. 20 is a flow chart of a method 600 for generating a suggested ad in an interpersonal electronic advertising system. In 602, merchant information can be received and merchant account can be generated. The merchant account can include an agreement that defines the relationship between the system and a merchant. For example, a rate structure for commission can be specified in the agreement.

In 604, the system can receive merchant product information. This can be done via an API between the system and Merchant, which is digitally and automatically updated on a regular basis, e.g., daily or weekly, as the product inventory updates.

In one embodiment, the merchant product information can include components that allow the system to generate a suggested ad for the product, such as a price, product description and image. The system may regularly receive updates from a merchant to reflect changes in their product line, such as price changes, commission changes, new products and discontinued products. For example, updates can be received on a daily or weekly basis. In another embodiment, a merchant can maintain a database of the products that they have available. Thus, part of the initial registration process can involve establishing an interface between the merchant and the system that allows the system to access the merchant database.

In 606, via the ad creation interface, the system can receive ad recipient information from the ad suggester. When this information is entered, a user may or may not be signed into the system. When the user is signed into the system, the user can use their previously entered contacts to select an ad recipient.

In 608, via the ad creation interface, the system can receive system consumer information. For example, the consumer information can be search terms that an ad suggester inputs into the system to locate suggested ads including products that are of interest to the ad recipient.

In 610, the system can receive a selection of a suggested ad. For example, in response to search terms received from the user, multiple suggested ads meeting the entered search criteria can be located and output via the interface. The user can select from among one of the multiple suggested ads. The user can also select from among recent or previously selected ads. Then, details of the selected ad, such as an image of the product, a price, a commission value and a payment time frame are known to the system and can be displayed to the user.

In 612, the system can generate and output a suggested ad. For example, the suggested ad can be output in the “send” tab portion of the interface previously described above. In one embodiment, the user can enter information, such as a personal message, that can be sent with the suggested ad to the recipient.

In 614, the ad suggester information can be received if this is not already known (for example, the user may or may not have already signed in). In one embodiment, the ad suggester information can be accessed when the user signs onto an existing account with the system. In another embodiment, the user can register for an account and specify this information during the registration process. The ad suggester information can be used to ad a name to the suggested ad, such as the first name of the ad suggester.

Next, the system can generate a message including the suggested ad and optionally the personal message that has been entered. For example, an email including the suggested ad and the personal message can be generated. In 616, the message including the suggested ad can be sent in some manner to the ad recipient. For example, the message can be e-mailed to the user or texted to the user.

### Network and Devices

FIG. 21 illustrates a diagram of a sample network 741 in which systems and methods consistent with the principles of the embodiments described herein may be implemented. Network 741 includes one or more clients 743 connected to one or more servers 745-747 via a network 749. Two clients 743 and two servers 745-747 have been illustrated as connected to network 749 for simplicity. In practice, there may be more or fewer clients and servers. Also, in some instances, a client performs a function of a server and a server performs a function of a client.

Clients 743 can be electronic devices, such as a personal computer, a wireless telephone, a personal digital assistant (PDA), a laptop computer, a mobile device, an mp3 player, a tablet, a television, a thin client, or any other type of computation of communication device, a thread or process running on one of these devices, or an object executable by one of these devices. One or more users (e.g., an ad suggester 4 or recipient 8) are associated with each client 743. Servers 745 and 747 include server entities that access, fetch, aggregate, process, search or maintain data in a manner consistent with the principals of the disclosure. Clients 743 and servers 745 and 747 connect to network 749 via at least one network interface that may include one or more wired, wireless, cellular or optical connections, or any other type of connection. The network interface relays communications to network 749. In one embodiment, clients 743 or servers 745 and 747 include a network interface dedicated to receiving input and a second network interface dedicated to send data to the network 749. In a specific embodiment, clients 743 or servers 745 and 747 includes a single network interface that both receives and sends data via the network 749.

In one embodiment, server 745 includes an advertisement system 751 useable by users at clients 743. Server 745 may implement an advertisement platform with advertisements from one or more vendors and sources, index the ads and store information associated with the ad data in a storage device. In some embodiments, server 745 hosts advertisements that are provided to users at clients 743. In one embodiment, ad system 751 provides an advertisement suggestion interface to clients 743. Via the interface, the ad system can provides a listing of ads that an add suggester can select. The system can be configured to receive electronic advertisement input. In some embodiments, the electronic advertisement input can be used in a search feature associated with the interface. The search feature can be used to locate particular ads that a user may wish to suggest. After ads are selected, ad system 751 can be configured to execute an advertisement provision function that allows a suggested ad to be sent an ad recipient. The ad recipient can access the suggested ads via one of the client devices.

Server 747 stores or maintains data that may be crawled by server 745. In one embodiment, the server 745 can store ad related data. Such data may include information described above for data storage 30.

Network 749 includes one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The telephone network may further include 3G, 4G, or Mobile WiMAX, Long Term Evolution (LTE). The PLMN(s) may further include a packet-switched sub-network, such as, for example, General Packet Radio Service (GPRS), Cellular Digital Packet Data (CDPD), or Mobile IP sub-network.

While servers 745 and 747 are shown as separate entities, it may be possible for one of servers 745 or 747 to perform one or more of the functions of the other one of servers 745 or 747. For example, servers 745 and 747 may be implemented as a single server. It may also be possible for a single one of servers 745 or 747 to be implemented as two or more separate (and possibly distributed) devices. In addition, in some embodiments, one or more functions attributed to the servers 745 and 747 in the description provided herein can also be implemented on one of the clients or vice versa.

FIG. 23 illustrates a sample computing system 761, which may correspond to one or more of clients 743 and/or servers 745-747. Computer system 761 comprises a processor, or CPU, 763, input device 775, output device 767, communication interface 769, system bus 771, one or more main memory 273, ROM 775, BIOS 777, and storage device 779. System bus 771 permits digital communication between system processor 763 and ROM 775, as well as permits communication between other components within system 761 and processor 763 and/or ROM 775.

Processor 763 is a commercially available microprocessor such as one of the Intel or AMD family of chips, or another suitable commercially available processor. Processor 763 digitally communicates with ROM 775 via system bus 771, which may comprise a data bus, control bus, and address bus for communication between processor 763 and memory 773. CPU 763 is also coupled to the communication interface 769 by system bus 771 to permit data transfers to and from computing system 761.

System memory can include read only memory (ROM), such as 775. Other memories may be included or substituted for ROM 775, such as random access memory (RAM) 773. Computer system 761 may also include a storage device 779, such as a hard disk drive or an optical disk drive, for example. The drives and their associated computer-readable media provide non-volatile storage for system 761. A number of program modules are stored in the drives, ROM 775, and/or RAM, including an operating system, one or more application programs, other program modules, and program data. Although data storage above refers to a hard disk and optical disk, those skilled in the art will appreciate that other types of storage are suitable for use with a computer system, such as magnetic cassettes, flash memory cards, USB memory sticks, and the like. In addition, not all computer systems, such as PDAs and other portable devices include multiple external memory options.

Communication interface 769 provides an interface between CPU 763 and such peripheral devices as a display device, input device 775, output 767, network interface, and/or any other I/O device. For example, a mouse used as input device 775 digitally communicates with processor 763 through a serial port 769 that is coupled to system bus 771. Other interfaces, such as a game port, a universal serial bus (USB) or fire wire, may also provide digital communication between a peripheral device and processor 763. Output 767 may comprise one or more speakers employed by a headphone or speaker system. Input device 775 allows a user to enter commands and information into the computer system 761, and may comprise a keyboard, a mouse, a position-sensing pad on a laptop computer, a stylus working in cooperation with a position-sensing display on a PDA, a touch screen system, a microphone, a touch sensitive device or the like.

In addition to personal computers such as desktop computers and laptop computers, a variety of other computer systems and computer devices employing a digital processor, memory and a display device may implement techniques described herein. Handheld computers and other small portable digital devices such as cell phones and digital cameras are increasingly integrating video display and computer functionality. One current trend is hybrid entertainment devices that integrate the functionality of computer systems, phones, and gaming systems. Any of these devices may implement the advertising methods and compensation systems described herein. The scope of digital computer systems is expanding hurriedly and creating new devices suitable for use herein.

Embodiments of the present invention further relate to computer readable media that include executable program instructions for performing interpersonal advertisement techniques described herein. The media and program instructions may be those specially designed and constructed for the purposes of the present invention, or any kind well known and available to those having skill in the computer software arts. When executed by a processor, these program instructions are suitable to implement any of the methods and techniques, and components thereof, described above. Examples of computer-readable media include, but are not limited to, magnetic media such as hard disks, semiconductor memory, optical media such as CD-ROM disks; magneto-optical media such as optical disks; and hardware devices that are specially configured to store program instructions, such as read-only memory devices (ROM), flash memory devices, EEPROMs, EPROMs, etc. and random access memory (RAM). Examples of program instructions include both machine code, such as produced by a compiler, and files containing higher-level code that may be executed by the computer using an interpreter.

Interpersonal advertising and compensation system software and interfaces such as those described herein may be implemented using a number of computer languages and in a number of programming environments. One suitable language is Java, available from Sun Microsystems of Sunnyvale, Calif. Another suitable programming environment is the Microsoft Windows™ programming environment, which provides a series of operating systems suitable for implementing the present invention both on laptop computers and handheld computers. C or C++ are also suitable for use herein.

Although the foregoing invention has been described in some detail for purposes of clarity of understanding, those skilled in the art will recognize that various modifications may be made within the scope of the appended claims. In addition, although advertising has not been detailed for every type of electronic device, the present invention is suitable with any technology that provides electronic advertisements. The invention is, therefore, not limited to the specific features and embodiments described herein and claimed in any of its forms or modifications within the scope of the appended claims.

What is claimed is:

1. A method in an interpersonal electronic advertising system, the method comprising:
controlling output in a processor of an electronic ad creation interface for a user of the system;
displaying via the interface a compensation amount, a product, and a price of the product wherein the commission amount is associated with the use of an electronic ad corresponding to the product;
receiving via the interface a designation of an ad recipient for the electronic ad;
displaying via the interface an image of the electronic ad, said electronic ad including a name of a user from which the designation of the ad recipient was received for the electronic ad, an image of the product, and the price of the product.

2. The method of claim 1, further comprising:
receiving, via the interface, consumer information;
based upon the consumer information searching a database within the system wherein the database includes information related to a first plurality of electronic ads;
locating a second plurality of electronic ads; and
receiving via the interface a selection of the electronic ad from among the second plurality of electronic ads.

3. The method of claim 2, further comprising: displaying via the interface information related to the second plurality of electronic ads.

4. The method of claim 1, further comprising:
receiving, via the interface, consumer information;
submitting a search request including the consumer information to an electronic device outside of the interpersonal electronic advertising system;
receiving from the electronic device information related to a plurality of electronic ads;
displaying via the interface information related to the plurality of electronic ads; and
receiving via the interface a selection of the electronic ad from among the plurality of electronic ads.

5. The method of claim 1, further comprising:
displaying via the interface a plurality of electronic ads wherein the electronic ad is selected from among the plurality of suggested ads;
receiving via the interface a selection of a second electronic ad; and
displaying via the interface for the second electronic ad, a second commission amount, a second product, and a second price.

6. The method of claim 5, wherein the ad recipient received for the electronic ad is associated with the second electronic ad unless a new ad recipient is received via the interface.

7. The method of claim 1, further comprising:
displaying via the interface information related to at least two electronic ads including the electronic ad and a second electronic ad wherein the electronic ad and the second electronic ad are for the same product or service and a merchant for the electronic ad and a merchant for the second electronic ad are different.

8. The method of claim 7, wherein the commission amount for the electronic ad is different than a commission amount for the second electronic ad.

9. The method of claim 1, further comprising:
displaying via the interface a time it takes to pay the commission amount for the electronic ad.

10. The method of claim 1, further comprising:
prior to displaying the commission amount, determining a commission amount for the electronic ad.

11. The method of claim 1, further comprising:
receiving via the interface an input of a personal message to include with the message.

12. The method of claim 1, further comprising:
receiving via the interface contact information for the ad recipient wherein the message is sent to the ad recipient using the contact information.

13. The method of claim 1, further comprising:
storing a name of the ad recipient and the contact information for the ad recipient to an account on the system associated with the user.

14. The method of claim 1, further comprising:
receiving via the interface a request from the user to register for an account with the system and in response to the request generating a state of the interface configured to receive registration information.

15. The method of claim 1, further comprising:
receiving a request to sign into the system and in response generating a state of the interface configured to receive sign in information from the user.

16. The method of claim 15, further comprising:
after the user has successfully signed in, retrieving the name of the user from an account associated with the sign in information.

17. The method of claim 15, further comprising:
after the user has successfully signed in, displaying via the interface a link to a dashboard interface that allows the user to view information related to their activities on the system.

18. The method of claim 15, further comprising:
after the user has successfully signed in, displaying via the interface a list of contacts wherein the ad recipient for the electronic ad is selected from the list of contacts.

19. The method of claim 15, further comprising:
after the user has successfully signed in, displaying via the interface a plurality of products for electronic ads that the user has previously sent.

20. The method of claim 19, wherein the product in the electronic ad corresponds to one of the plurality of products for the electronic ads that the user has previously sent.

21. The method of claim 19, wherein the interface is configured to receive a selection of any of the products for the plurality of electronic ads the user has previously sent and in response, display via the interface a commission amount, a product, a product description and a merchant through the product can be purchased for selected electronic ad.

22. The method of claim 15, further comprising:
after the user has successfully signed in, displaying via the interface a plurality of electronic ads that have been sent to the user wherein each of the plurality of electronic ads includes a name of a person that has designated the user as a recipient for the electronic ads.

23. The method of claim 1, further comprising:
receiving a request to register a merchant with the system; and
in response to the request, generating a state of the interface configured to receive merchant registration information.

24. The method of claim 1, further comprising:
receiving a request that allows a merchant to sign into the system; and
in response to the request, generating a state of the interface configured to receive merchant sign in information.

25. The method of claim 1, wherein the system is configured to not send the message including the image of the electronic ad when the system is unable to determine name of the user that has selected the electronic ad.

26. The method of claim 1, further comprising:
receiving via the interface a selection of a payment destination for the electronic ad.

27. The method of claim 1, further comprising:
receiving via the interface a request to add a payment destination; and
in response to the request, generating a state of the interface configured to receive payment destination information.

28. The method of claim 1, further comprising:
displaying via the interface the commission amount for the electronic ad;
receiving via the interface sign in information from the user;
after validating the sign in information, displaying via the interface a second commission amount for the electronic ad different from the commission amount.

29. A computer readable medium including instructions for a processor in an interpersonal electronic advertising system, the computer-readable medium comprising:
computer code for controlling output in a processor of an electronic ad creation interface for a user of the system;
computer code for displaying via the interface a compensation amount, a product, and a price of the product wherein the commission amount is associated with the use of an electronic ad corresponding to the product;
computer code for receiving via the interface a designation of an ad recipient for the electronic ad;
computer code for displaying via the interface an image of the electronic ad, said electronic ad including a name of a user from which the designation of the ad recipient was received for the electronic ad, an image of the product, and the price of the product.
